(19) United States
(12) Patent Application Publication
(10) Pub. No.: US 2026/0267101 A1
(43) Pub. Date: Sep. 10, 2026

(54) OPTICAL FIBER FOR HIGH DENSITY CABLE

(71) Applicant: CORNING INCORPORATED, Corning, NY (US)

(72) Inventors: Aleksandra Boskovic, Elmira, NY (US); Pushkar Tandon, Painted Post, NY (US); Kenneth Darrell Temple, JR., Newton, NC (US); Wendell Porter Weeks, Corning, NY (US)

(21) Appl. No.: 19/553,707

(22) Filed: Mar. 2, 2026

Related U.S. Application Data
(60) Provisional application No. 63/766,654, filed on Mar. 4, 2025.

(51) Int. Cl. G02B 6/44; G02B 6/02

(52) U.S. Cl. CPC G02B 6/443; G02B 6/02004; G02B 6/02214

(57) ABSTRACT

The disclosure provides optical fibers with a low coated diameter and low sensitivity to microbending. Low microbending sensitivity is achieved by (1) configuring the relative refractive index profile of the optical fiber to have a mode field diameter less than or equal to 8.2 μm at 1310 nm and (2) reducing the in situ modulus of the primary coating to less than or equal to 0.25 MPa. The optical fiber preferably includes a secondary coating with an in situ modulus greater than or equal to 1200 MPa. The outer radius of the secondary coating is less than or equal to 82.5 μm. The relative refractive index profile of the optical fiber preferably includes a trench cladding region with a moat volume greater than or equal to 30% Δ-μm². The optical fibers enable high fiber density in cables.

This application claims the benefit of priority to U.S. Provisional Patent Application No. 63/766,654 filed on Mar. 4, 2025, the content of which is relied upon and incorporated herein by reference in its entirety.

### FIELD OF THE DISCLOSURE

This disclosure pertains to optical fibers and cables. More particularly, this disclosure pertains to optical fibers and cables designed for data center applications. Most particularly, this disclosure pertains to optical fibers with low diameter and cables having a high density of optical fibers to increase data transmission capacity.

### BACKGROUND OF THE DISCLOSURE

Optical fibers are being widely used in telecommunication applications including in Fiber to the Home (FTTH), data centers, and silicon photonics. Continued demand for higher data throughput and more compact optical networks is placing increasingly stringent requirements on the performance of optical fibers. In particular, the need for higher fiber density in cables and limited space for fiber installation is motivating efforts to develop bend-insensitive optical fibers. Bend-insensitive optical fibers are optical fibers that exhibit minimal signal loss due to bending.

Bend loss includes signal losses due to microbending and macrobending. Microbending losses are caused by high frequency mechanical perturbations originating from external stimuli in the deployment environment of the optical fiber. Examples include lateral contact of the optical fiber with surfaces in a cable (e.g. tube wall or neighboring fibers). Physically, microbends correspond to randomly localized small radius bends (less than about 1 mm) that act along the length of the optical fiber. Microbends lead to mode coupling in the optical fiber and dissipation of power in the fundamental mode of single mode fiber into higher order modes.

Macrobending losses are signal losses caused by turning or winding of the optical fiber in the deployment environment. It is often necessary to physically bend an optical fiber to meet installation requirements in the field (e.g. around corners or in tight spaces in data centers or in-building networks). The bend diameter in physical installations is large (greater than about 2 mm and typically on the order of tens of millimeters) and the loss mechanism is leakage of light. As the optical fiber bends, a fraction of the optical signal refracts or tunnels out of the core to the cladding and is dissipated in the protective coating surrounding the fiber. The amount of lost signal increases as the optical fiber is bent more tightly (smaller bend diameter).

To meet the demand for high data transmission capacity in data centers, it is necessary to develop cables with an increasingly higher number of data channels per unit cross-sectional area of the cable.

One strategy for increasing the number of data channels in cables is to continue the current practice of constructing cables with standard optical fibers but to reduce the diameter of the optical fibers utilized in the cable. Standard optical fibers consist of a glass fiber surrounded by a protective coating. The glass fiber includes a central waveguiding core surrounded by a cladding. The diameter of an optical fiber can be reduced by reducing the thickness of the glass cladding or the thickness of the protective coating. While viable, both approaches present challenges that need to be overcome. If the thickness of the glass cladding is reduced, the waveguiding core of the glass fiber is in closer proximity to the coating and signal losses to the coating increase.

Reducing the diameter of optical fibers by reducing the thickness of the protective coating is currently a practiced solution for increasing fiber density in cables. Standard optical fibers have glass diameter of 125 μm and a coated diameter of about 240 μm (coating thickness of about 57.5 μm). Recent innovations have produced optical fibers with coated diameters of 190 μm (coating thickness of about 32.5 μm) and implementing such optical fibers in cables has enabled increases in fiber density in loose fiber cables up to about 10 fibers/mm². It would be desirable to develop optical fibers with coated diameters less than 190 μm to enable higher fiber density in cables. As coating thickness decreases, however, the spacing between optical fibers decreases and contact between adjacent optical fibers increases. As a result, mechanical interactions that occur at the coating interface between adjacent optical fibers in a cable have a more pronounced effect on the optical signals transmitted through the cores of the optical fibers, which leads to greater microbending losses. A similar effect occurs if the thickness of the coating is maintained and the thickness of the glass cladding is reduced due to closer proximity of the cores of the optical fiber to the coating interface between adjacent optical fibers in a cable.

With the recent development of AI (artificial intelligence), the demand for further increases in data transmission capacity is expected to grow, prompting a need for further increases in fiber density in cables and further reductions in the diameter of optical fibers. Microbending losses become particular pronounced when cables are deployed in low temperature environments. Microbending of optical fiber is manifested in high density cables through attenuation increase in attenuation the fibers in high density experience during thermal cycling. Reducing the coating thickness results in increased microbending sensitivity with the same coating material. There is accordingly a need for new optical fibers with increasingly lower diameter and increasingly lower sensitivity to microbending for assembly at high density in cables to meet future demands for high data transmission capacity in data centers.

### SUMMARY

The present disclosure provides optical fibers with a low coated diameter and low sensitivity to microbending. Low microbending sensitivity is achieved by (1) configuring the relative refractive index profile of the optical fiber to have (i) a low mode field diameter, and (ii) a deep trench, (2) reducing the modulus of the primary coating that directly contacts the glass fiber, and (3) increasing the modulus of the secondary coating and the colored layer. In one embodiment, the mode field diameter is less than or equal to 8.2 μm at 1310 nm, the trench volume of the refractive index profile is larger than 30% Δ-μm², the in situ modulus of the primary coating is less than or equal to 0.25 MPa, and the in situ modulus of the secondary coating is greater than 1400 MPa. The higher modulus secondary coating surrounds and is in direct contact with the lower modulus primary coating. The outer diameter of the secondary coating is less than or equal to 165.0 μm and the secondary coating preferably has an in situ modulus greater than or equal to 1400 MPa. The relative refractive index profile of the optical fiber preferably includes a trench cladding region with a moat volume greater than or equal to 30% Δ-μm². Embodiments with rectangular and triangular trench cladding regions are included. Further embodiments include glass fibers with a cladding radius less than 62.5 μm.

The present description extends to:

An optical fiber comprising:
a glass fiber, the glass fiber comprising:
   a core region, the core region having an outer radius r₁ and a relative refractive index Δ₁ with a maximum relative refractive index Δ₁ₘₐₓ;
   a cladding region surrounding and directly adjacent to the core region, the cladding region having an outer radius r₄;
a primary coating surrounding and directly adjacent to the cladding region, the primary coating having a radius r₅, a thickness r₅−r₄, and an in situ modulus less than or equal to 0.30 MPa;
a secondary coating surrounding and directly adjacent to the cladding region, the secondary coating having a thickness r₆−r₅, an in situ modulus greater than or equal to 1400 MPa, and an outer radius r₆ less than or equal to 82.5 μm;
wherein the optical fiber has a mode field diameter between 7.3 μm and 8.2 μm at 1310 nm and a macrobend loss at 1550 nm, as determined by a mandrel wrap test using a mandrel with a diameter of 15 mm, of less than or equal to 0.5 dB/turn.

The present disclosure extends to:

An optical fiber ribbon comprising the optical fibers disclosed herein.

The present disclosure extends to:

An optical fiber cable comprising the optical fibers disclosed herein.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 is a schematic view of a coated optical fiber according to one embodiment.

FIG. 2 is a schematic view of a representative optical fiber ribbon.

FIG. 3 is a schematic view of a representative optical fiber cable.

FIG. 4A depicts a cross-sectional view of an optical fiber having a core region, a trench cladding region, an outer cladding region, a primary coating, and a secondary coating.

FIG. 4B depicts a cross-sectional view of an optical fiber having a core region, an offset cladding region, a trench cladding region, an outer cladding region, a primary coating, and a secondary coating.

FIG. 5A depicts a relative refractive index profile of a glass fiber having a core region with a graded index, a trench cladding region, and an outer cladding region.

FIG. 5B depicts a relative refractive index profile of a glass fiber having a core region with a graded index, an offset cladding region, a trench cladding region, and an outer cladding region.

FIG. 5C depicts a relative refractive index profile of a glass fiber having a core region with a graded index, a trench cladding region, and an outer cladding region.

FIG. 5D depicts a relative refractive index profile of a glass fiber having a core region with a graded index, an offset cladding region, a trench cladding region, and an outer cladding region.

FIG. 6A depicts a relative refractive index profile of a glass fiber having a core region with a step index, a trench cladding region, and an outer cladding region.

FIG. 6B depicts a relative refractive index profile of a glass fiber having a core region with a step index, an offset cladding region, a trench cladding region, and an outer cladding region.

FIG. 6C depicts a relative refractive index profile of a glass fiber having a core region with a step index, a trench cladding region, and an outer cladding region.

FIG. 6D depicts a relative refractive index profile of a glass fiber having a core region with a step index, an offset cladding region, a trench cladding region, and an outer cladding region.

FIG. 7A is a schematic depiction of soot preform deposition via an OVD process.

FIG. 7B depicts an apparatus for doping and consolidating a soot preform.

FIGS. 8A-8C depict deposition of a plurality of soot layers on a substrate.

FIG. 9A illustrates the variation in the Microbending Sensitivity Parameter with the in situ modulus of the primary coating for a representative optical fiber.

FIG. 9B illustrates the variation in the Microbending Sensitivity Parameter with the in situ modulus of the secondary coating for a representative optical fiber;

FIG. 9C illustrates a relationship that shows the in situ modulus of the secondary coating required to achieve good puncture resistance as the diameter 2R₆ of the secondary coating decreases.

FIG. 9D illustrates the microbending sensitivity for embodiments having a glass diameter less than 125 μm.

FIG. 10 is a diagram illustrating modeled relationships between optical fiber diameter and fiber density in a loose fiber optical fiber cable.

FIG. 11 is a cross-sectional view of an exemplary optical fiber cable.

FIG. 12 is a diagram illustrating modeled relationships between coefficient of thermal expansion of a cable jacket and an achievable optical fiber density in an optical fiber cable.

FIG. 13 depicts the relative refractive index profile of a manufactured optical fiber.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:

“Include,” “includes,” or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within ±10% of the number. For example, a value that is about 10 refers to a value between 9 and 11, inclusive.

Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, distance, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. It will be further understood that the end-points of each of the ranges are significant both in relation to the other end-point, and independently of the other end-point. Finally, when the term “about” is used in describing a value or an end point of a range, the disclosure should be understood to include the specific value or end point referred to. When a numerical value or end point of a range does not recite “about,” the numerical value or end point of a range is intended to include two embodiments: one modified by “about,” and one not modified by “about.”

As used herein, “comprising” is an open-ended transitional phrase. A list of elements following the transitional phrase “comprising” is a non-exclusive list, such that elements in addition to those specifically recited in the list may also be present.

The term “wherein” is used as an open-ended transitional phrase, to introduce a recitation of a series of characteristics of the structure.

The terms “comprising,” and “comprises,” e.g., “A comprises B,” is intended to include as special cases the concepts of “consisting of” and “consisting essentially of” as in “A consists of B” or “A consists essentially of B”.

The term “or,” as used herein, is inclusive; more specifically, the phrase “A or B” means “A, B, or both A and B.” Exclusive “or” is designated herein by terms such as “either A or B” and “one of A or B,” for example.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other but are rigidly or flexibly joined through one or more intervening materials. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Optical fiber” refers to a waveguide having a glass portion surrounded by a coating. The glass portion includes a core and a cladding. The glass portion is referred to herein as a “glass fiber”.

“Radial position”, “radius”, or the radial coordinate “r” refers to radial position relative to the centerline (r=0) of the glass fiber.

The terms “inner” and “outer” are used to refer to relative values of radial coordinate or relative positions of regions of the optical fiber, where “inner” means closer to the centerline of the fiber than “outer”. An inner radial coordinate is closer to the centerline of the glass fiber than an outer radial coordinate. An inner radial coordinate is between the centerline of the glass fiber and an outer radial coordinate. An inner region of an optical fiber is closer to the centerline of the glass fiber than an outer region. An inner region of an optical fiber is between the centerline of the glass fiber and the outer region of the glass fiber.

The term “mode” refers to guided mode. A single-mode optical fiber is an optical fiber designed to support only the fundamental LP01 modes over a substantial length of the optical fiber (e.g., at least several meters), but that under certain circumstances can support multiple modes over short distances (e.g., tens of centimeters). The optical fibers disclosed herein are single-mode optical fibers at a wavelength of 1550 nm.

“Refractive index” refers to the refractive index at a wavelength of 1550 nm.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ % or %) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by Δₐᵥₑ given in Eq. (2) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) for any radial position r as:

$$Δ \% = 100 \frac{( {n}^{2} - {n}_{ref}^{2} )}{2 {n}^{2}} \qquad ( 1 )$$

where n is the refractive index at the radial position r in the glass fiber and n_{ref} is the refractive index of pure silica glass. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ % (or “delta %) and its values are given in units of “%”, unless otherwise specified. Relative refractive index may also be expressed as Δ(r) or Δ(r) %. When referring to a specific region i of the optical fiber, relative refractive index may also be expressed as Δᵢ, Δᵢ %, Δᵢ(r) or Δᵢ(r) %.

The average relative refractive index (Δₐᵥₑ) of a region of the fiber is determined from Eq. (2):

$${Δ}_{a v e} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

The term “α-profile” refers to a relative refractive index profile Δ(r) that has the functional form defined in Eq. (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number. Δ(r₀) for an α-profile may be referred to herein as Δₘₐₓ or, when referring to a specific region i of the fiber, as Δ_{i,max}. When the relative refractive index profile of the fiber core region is described by an α-profile with r₀ occurring at the centerline (r=0) and r_{z} corresponding to the outer radius r₁ of the core region, and Δ₁(rᵢ)=0, Eq. (3) simplifies to Eq. (4):

$${Δ}_{1} ( r ) = {Δ}_{1 max} [ 1 - {[ \frac{r}{{r}_{1}} ]}^{α} ] \qquad ( 4 )$$

“Effective area” of an optical fiber is defined as:

$${A}_{eff} = \frac{2 {π [ {\int }_{0}^{∞} {( f ( r ) )}^{2} r dr ]}^{2}}{{\int }_{0}^{∞} {( f ( r ) )}^{4} r dr}$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm, unless otherwise specified.

The “mode field diameter” or “MFD” of an optical fiber is defined in Eq. (5) as:

$$MFD = 2 w \qquad ( 5 )$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal and r is radial position in the fiber. “Mode field diameter” or “MFD” depends on the wavelength of the optical signal in the optical fiber. Specific indication of the wavelength will be made when referring to mode field diameter herein. Unless otherwise specified, mode field diameter refers to the LP₀₁ mode at the specified wavelength.

“Trench” or “trench region” or “trench cladding region” refers to the portion of the cladding surrounded by and directly adjacent to an outer cladding region. A trench is situated between the outer radius r₁ of the core and the inner radius r₃ of the outer cladding region and has a relative refractive index Δ₃ less than the relative refractive index Δ₄ of the outer cladding region. In some embodiments, a trench is directly adjacent to the core. In other embodiments, an offset cladding region surrounds and is directly adjacent to the core, and a trench cladding region surrounds and is directly adjacent to the offset cladding region, where the offset cladding region has a relative refractive index Δ₂ less than the relative refractive index Δ₁ of the core and greater than the relative refractive index Δ₃ of the trench cladding region.

“Trench volume” is defined as:

$${V}_{Trench} = 2 \vert {\int }_{{r}_{Trench , inner}}^{{r}_{Trench , outer}} ( {Δ}_{Trench} ( r ) - {Δ}_{4} ) rdr \vert \qquad ( 6 )$$

where r_{Trench,inner} is the inner radius r₂ of the trench cladding region, r_{Trench,outer} is the outer radius r₃ of the trench cladding region, Δ_{Trench}(r)=Δ₃(r) is the relative refractive index of the trench cladding region, and Δ₄ is the average relative refractive index of the outer cladding region of the glass fiber. In embodiments in which a trench is directly adjacent to the core, r_{Trench,inner} is r₂=r₁ (outer radius of the core), r_{Trench,outer} is r₃, and Δ_{Trench} is Δ₃(r). In embodiments in which a trench is directly adjacent to an offset cladding region, r_{Trench,inner} is r₂>rᵢ, r_{Trench,outer} is r₃, and Δ_{Trench} is Δ₃(r). Trench volume is defined as an absolute value and has a positive value. Trench volume is expressed herein in units of % Δ-micron², % Δ-m², or %-micron², %-μm², whereby these units can be used interchangeably herein.

“Chromatic dispersion”, herein referred to as “dispersion” unless otherwise noted, of an optical fiber is the sum of the material dispersion, the waveguide dispersion, and the intermodal dispersion. In the case of single mode waveguide fibers, the inter-modal dispersion is zero. Dispersion varies with wavelength and can be positive or negative. The zero-dispersion wavelength (λ₀) is the wavelength at which dispersion is zero. Dispersion slope is the variation in dispersion with wavelength. Dispersion is reported herein in units of ps/nm/km. Dispersion slope is reported herein in units of ps/nm²/km.

The cutoff wavelength of an optical fiber is the minimum wavelength at which the optical fiber will support only one propagating mode. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres—Part 1-44: Measurement Methods and Test Procedures—Cut-off Wavelength (21 May 2003), by Telecommunications Industry Association (TIA).

The term “bend diameter” refers to the diameter of the mandrel used to determine macrobend loss using the mandrel wrap test specified in the standard TIA-455-62: FOTP-62 IEC-60793-1-47 Optical Fibres—Part 1-47: Measurement Methods and Test Procedures—Macrobending Loss, by Telecommunications Industry Association (TIA).

The optical fibers disclosed herein include a core region, a cladding region surrounding the core region, and a coating surrounding the cladding region. The core region and cladding region are glass. The cladding region includes multiple regions that may differ in relative refractive index. The multiple cladding regions are preferably concentric regions. In preferred embodiments, the cladding region includes a trench cladding region. The trench cladding region surrounds the core region and is surrounded by and directly adjacent to an outer cladding region. In some embodiments, the trench cladding region is directly adjacent to the core region. In other embodiments, the trench cladding region is directly adjacent to an offset cladding region and the offset cladding region is directly adjacent to the core region. The core region, cladding region, trench cladding region, and outer cladding region are also referred to as core, cladding, trench, and outer cladding, respectively. The offset cladding region is optional and may also be referred to herein as an offset.

Whenever used herein, radial position r₁ and relative refractive index Δ₁ or Δ₁(r) refer to the core region, radial position r₂ and relative refractive index Δ₂ or Δ₂(r) refer to the offset cladding region, radial position r₃ and relative refractive index Δ₃ or Δ₃(r) refer to the trench cladding region, radial position r₄ and relative refractive index Δ₄ or Δ₄(r) refer to the outer cladding region.

The relative refractive index Δᵢ(r) has a maximum value Δ₁ₘₐₓ and a minimum value Δ₁ₘᵢₙ. The relative refractive index Δ₂(r) has a maximum value Δ₂ₘₐₓ and a minimum value Δ₂ₘᵢₙ. The relative refractive index Δ₃(r) has a maximum value Δ₃ₘₐₓ and a minimum value Δ₃ₘᵢₙ. The relative refractive index Δ₄(r) has a maximum value Δ₄ₘₐₓ and a minimum value Δ₄ₘᵢₙ. In embodiments in which the relative refractive index is constant or approximately constant over a region, the maximum and minimum values of the relative refractive index are equal or approximately equal. Unless otherwise specified, if a single value is reported for the relative refractive index of a region, the single value corresponds to an average value for the region.

It is understood that the core region is the central region of the glass fiber and is substantially cylindrical in shape, and that a surrounding optional offset cladding region, a surrounding trench cladding region, and a surrounding outer cladding region are substantially annular in shape. Annular regions may be characterized in terms of an inner radius and an outer radius. Radial positions r₁, r₂, r₃, and r₄ refer herein to the outermost radii of the core region, offset cladding region, trench cladding region, and outer cladding region, respectively. The radius r₄ corresponds to the outer radius of the glass fiber.

When two regions are directly adjacent to each other, the outer radius of the inner of the two regions coincides with the inner radius of the outer of the two regions. In one embodiment, for example, the glass fiber includes a trench cladding region surrounded by and directly adjacent to an outer cladding region. In such an embodiment, the radius r₃ corresponds to the outer radius of the trench cladding region and the inner radius of the outer cladding region. In embodiments in which the relative refractive index profile includes a trench cladding region directly adjacent to the core, the radial position r₁ corresponds to the outer radius of the core and the inner radius r₂ of the trench cladding region. In all embodiments herein, the trench cladding region has an inner radius r₂ and an outer radius r₃. In embodiments having an offset cladding region, the radius r₂>r₁ and corresponds to the outer radius of the offset cladding region and the inner radius of the trench cladding region. In embodiments without an offset cladding region, the radius r₂=r₁ corresponds to the outer radius of the core region and the inner radius of the trench cladding region.

The following terminology applies to embodiments in which the relative refractive index profile includes an offset cladding region surrounding and directly adjacent to the core region, a trench cladding region surrounding and directly adjacent to the offset cladding region, and an outer cladding region surrounding and directly adjacent to the trench cladding region. The difference between radial position r₂ and radial position r₁ is referred to herein as the thickness or width of the offset cladding region. The difference between radial position r₃ and radial position r₂ is referred to herein as the thickness or width of the trench cladding region. The difference between radial position r₄ and radial position r₃ is referred to herein as the thickness or width of the outer cladding region.

The following terminology applies to embodiments in which a trench cladding region is directly adjacent to a core region and an outer cladding region is directly adjacent the trench cladding region. The difference between radial position r₃ and radial position r₂=r₁ is referred to herein as the thickness or width of the trench cladding region. The difference between radial position r₄ and radial position r₃ is referred to herein as the thickness or width of the outer cladding region.

As will be described further hereinbelow, the relative refractive indices of the core region, offset cladding region, trench cladding region, and outer cladding region may differ. Each of the regions is formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In one embodiment, the undoped glass is pure silica glass. When the undoped glass is pure silica glass, updopants include Cl, Br, Ge, Al, P, Ti, Zr, Nb, and Ta, and downdopants include F and B. Regions of constant refractive index may be formed by not doping (e.g. pure silica) or by doping at a uniform concentration. Regions of variable refractive index are formed through non-uniform spatial distributions of dopants and/or through incorporation of different dopants in different regions. Refractive index varies approximately linearly with the concentration of the updopant or downdopant. For example, each 1 wt % Cl as a dopant in silica glass increases the relative refractive index by about 0.083% and each 1 wt % F as a dopant in silica glass decreases the relative refractive index by about 0.32%.

The coatings formed on glass fibers are formed from curable coating compositions. Curable coating compositions include one or more curable components. As used herein, the term “curable” is intended to mean that the component, when exposed to a suitable source of curing energy, includes one or more curable functional groups capable of forming covalent bonds that participate in linking the component to itself or to other components of the coating composition. The product obtained by curing a curable coating composition is referred to herein as the cured product of the composition. The cured product is preferably a polymer. The curing process is induced by energy. Forms of energy include radiation or thermal energy. In a preferred embodiment, curing occurs with radiation, where radiation refers to electromagnetic radiation. Curing induced by radiation is referred to herein as radiation curing or photocuring. A radiation-curable component is a component that can be induced to undergo a curing reaction when exposed to radiation of a suitable wavelength at a suitable intensity for a sufficient period of time. Suitable wavelengths include wavelengths in the infrared, visible, or ultraviolet portion of the electromagnetic spectrum. The radiation curing reaction occurs in the presence of a photoinitiator. A radiation-curable component may also be thermally curable. Similarly, a thermally curable component is a component that can be induced to undergo a curing reaction when exposed to thermal energy of sufficient intensity for a sufficient period of time. A thermally curable component may also be radiation curable.

A curable component includes one or more curable functional groups. A curable component with only one curable functional group is referred to herein as a monofunctional curable component. A curable component having two or more curable functional groups is referred to herein as a multifunctional curable component. Multifunctional curable components include two or more functional groups capable of forming covalent bonds during the curing process and can introduce crosslinks into the polymeric network formed during the curing process. Multifunctional curable components may also be referred to herein as “crosslinkers” or “curable crosslinkers”. Curable components include curable monomers and curable oligomers. Examples of functional groups that participate in covalent bond formation during the curing process are identified hereinafter.

The term “(meth)acrylate” means methacrylate, acrylate, or a combination of methacrylate and acrylate.

Reference will now be made in detail to illustrative embodiments of the present description.

The present description relates to glass fibers and optical fibers having low mode field diameter at 1310 nm, low outer coating diameter, and low macrobend loss at 1550 nm and bend diameters ranging from 10 mm to 40 mm and low microbending sensitivity. Bend diameters greater than 25 mm are commonly encountered when attaching connectors to optical fibers and bend diameters less than 25 mm are commonly encountered when positioning or configuring optical fibers in tight or compact installation spaces. As described herein, macrobend loss at various bend diameters over the range from 10 mm to 40 mm can be mitigated through proper design of the refractive index profile of the optical fiber. Low microbend sensitivity is achieved by reducing mode field diameter, increasing trench volume, reducing the in situ modulus of the primary coating and increasing modulus of the secondary coating.

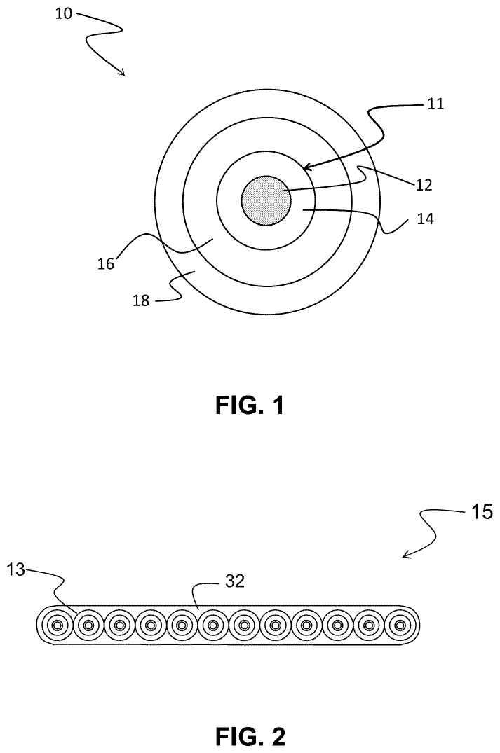

One embodiment relates to an optical fiber. An optical fiber includes a glass fiber surrounded by a coating. An example of an optical fiber is shown in schematic cross-sectional view in FIG. 1. Optical fiber 10 includes a glass fiber 11 surrounded by primary coating 16 and secondary coating 18. Further description of glass fiber 11, primary coating 16, and secondary coating 18 is provided below.

FIG. 2 illustrates a planar optical fiber ribbon 15. The ribbon 15 includes a plurality of optical fibers 13 and a matrix 32 encapsulating the plurality of optical fibers. Optical fibers 13 include a core region, a cladding region, a primary coating, and a secondary coating as described above. Optical fibers 13 may also include a tertiary coating. Either of the secondary or tertiary coating may include a pigment. The optical fibers 13 are aligned relative to one another in a substantially planar and parallel relationship. The optical fibers 13 in fiber optic ribbon 15 are encapsulated by the ribbon matrix 32 in any known configuration (e.g., edge-bonded ribbon, thin-encapsulated ribbon, thick-encapsulated ribbon, or multi-layer ribbon) by conventional methods of making fiber optic ribbons. In FIG. 2, the fiber optic ribbon 15 contains twelve (12) optical fibers 13; however, it should be apparent to those skilled in the art that any number of optical fibers 13 (e.g., two or more) may be employed to form fiber optic ribbon 15 disposed for a particular use. By way of example, and not limitation, the fiber optic ribbon 15 can include eight (8) optical fibers 13, sixteen (16) optical fibers 13, twenty-four (24) optical fibers 13, or thirty-two (32) optical fibers 13. The ribbon matrix 32 can be formed from the same composition used to prepare a secondary coating, or the ribbon matrix 32 can be formed from a different composition that is otherwise compatible for use.

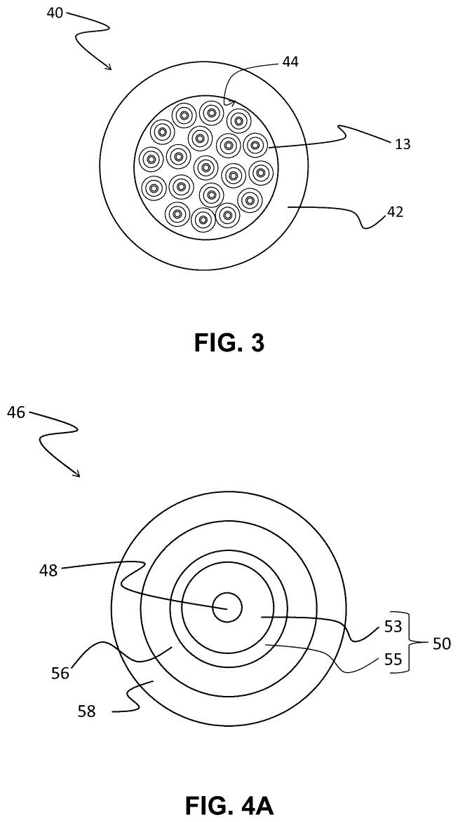

FIG. 3 illustrates an optical fiber cable 40. Cable 40 includes a plurality of optical fibers 13 surrounded by jacket 42. Optical fibers 13 may be densely or loosely packed into a conduit enclosed by inner surface 44 of jacket 42. The number of fibers placed in jacket 42 is referred to as the “fiber count” of optical fiber cable 40. The jacket 42 is formed from an extruded polymer material and may include multiple concentric layers of polymers or other materials. Optical fiber cable 40 may include one or more strengthening members (not shown) embedded within jacket 42 or placed within the conduit defined by inner surface 44. Strengthening members include fibers or rods that are more rigid than jacket 42. The strengthening member is made from metal, braided steel, glass-reinforced plastic, fiberglass, or other suitable material. Optical fiber cable 40 may include other layers surrounded by jacket 42 (e.g. armor layers, moisture barrier layers, rip cords, etc.). Optical fiber cable 40 may have a stranded, loose tube core or other fiber optic cable construction. Additional embodiments of optical fiber cable 40 are described in greater detail below. Among the findings disclosed herein is that the microbending sensitivity of cables with loose fiber is systematically smaller compared to the cables with ribbon cables and hence permit higher fiber densities in the cable with the same optical fiber, while having similar attenuation increase during thermal cycling.

Glass Fiber. The optical fibers disclosed herein include a glass fiber with a core region and a cladding region surrounding the core region along with a coating surrounding the cladding region. The core region and cladding region are glass. Glass fiber 11 includes a core region 12 and a cladding region 14 (see FIG. 1), as is familiar to the skilled artisan. Core region 12 has a higher refractive index than cladding region 14 and glass fiber 11 functions as a waveguide.

In many applications, the core region and cladding region have a discernible core-cladding boundary. Alternatively, the core region and cladding region can lack a distinct boundary. One type of optical fiber is a step-index optical fiber. Another type of optical fiber is a graded-index optical fiber, which has a core region with a refractive index that varies with radial position from the centerline (r=0) of the optical fiber. Examples of graded-index optical fibers are optical fibers with a core region having a relative refractive index profile characterized by the α-profile defined by Eq. (3) above. For purposes of the present disclosure, a step-index optical fiber has a core region with a relative refractive index profile described by the α-profile defined by Eq. (3) above, where the value of the parameter α is greater than or equal to 10.

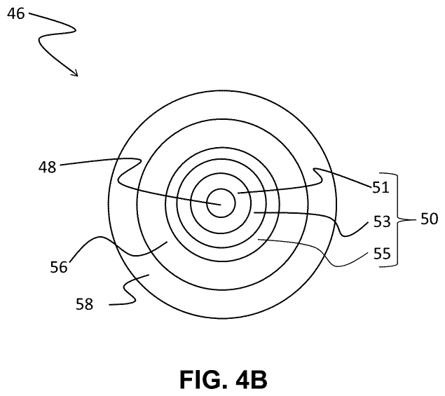

Schematic cross-sectional depictions of an optical fiber are shown in FIGS. 4A and 4B. In FIG. 4A, optical fiber 46 includes core region 48, cladding region 50, primary coating 56, and secondary coating 58. Cladding region 50 includes trench cladding region 53 and outer cladding region 55. In FIG. 4B, optical fiber 46 includes core region 48, cladding region 50, primary coating 56, and secondary coating 58. Cladding region 50 includes offset cladding region 51, trench cladding region 53, and outer cladding region 55.

In one embodiment (e.g. FIG. 4A), the optical fiber includes a trench cladding region surrounding a core, an outer cladding region surrounding the trench cladding region, a primary coating surrounding the outer cladding region, and a secondary coating surrounding the primary coating. The trench cladding region is directly adjacent to the core region, the outer cladding region is directly adjacent to the trench cladding region, the primary coating is directly adjacent to the outer cladding region, and the secondary coating is directly adjacent to the primary coating. A tertiary layer (e.g. ink layer) optionally surrounds or is directly adjacent to the secondary coating in the foregoing embodiment.

In another embodiment (e.g. FIG. 4B), the optical fiber includes an offset cladding region surrounding a core, a trench cladding region surrounding the offset cladding region, an outer cladding region surrounding the trench cladding region, a primary coating surrounding the outer cladding region, and a secondary coating surrounding the primary coating. The offset cladding region is directly adjacent to the core region, the trench cladding region is directly adjacent to the offset cladding region, the outer cladding region is directly adjacent to the trench cladding region, the primary coating is directly adjacent to the outer cladding region, and the secondary coating is directly adjacent to the primary coating. A tertiary layer (e.g. ink layer) optionally surrounds or is directly adjacent to the secondary coating in the foregoing embodiment.

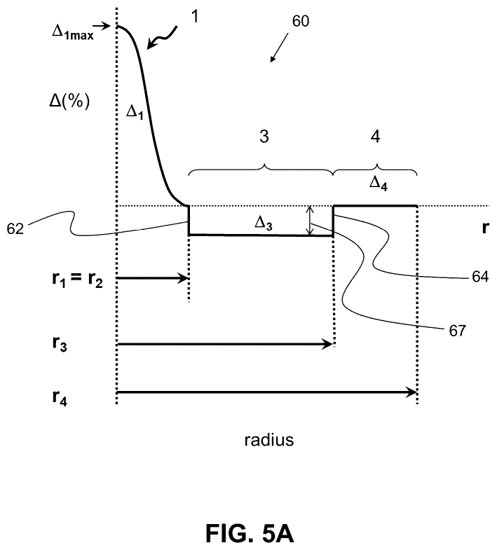

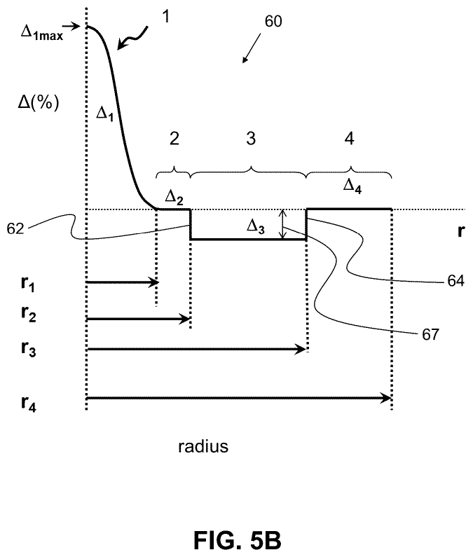

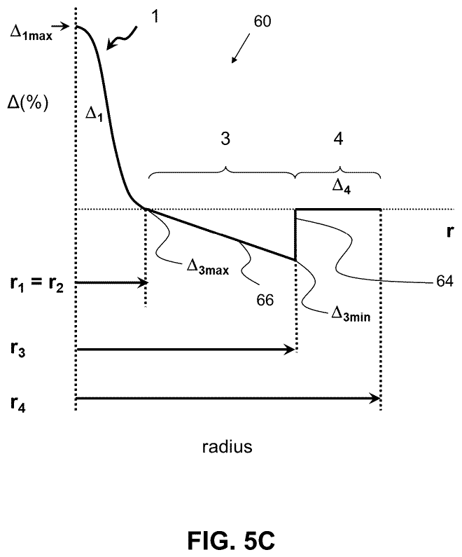

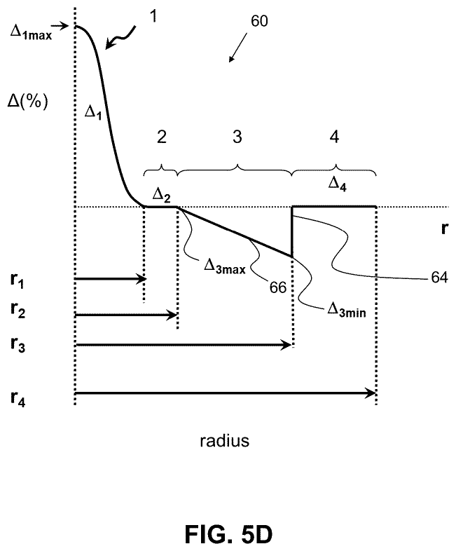

Representative relative refractive index profiles for a glass fiber are presented in FIGS. 5A-5D.

FIG. 5A shows a graded index profile for a glass fiber 60 having a core region (1) with outer radius r₁ and relative refractive index Δ₁ with maximum relative refractive index Δ₁ₘₐₓ, a trench cladding region (3) extending from radial position r₂=r₁ to radial position r₃ and having relative refractive index Δ₃, and an outer cladding region (4) extending from radial position r₃ to radial position r₄ and having relative refractive index Δ₄. In the embodiment of FIG. 5A, relative refractive index Δ₃ is constant or approximately constant from inner radius r₂ of the trench cladding region (3) to the outer radius r₃ of the trench cladding region (3).

FIG. 5B shows a graded index profile for a glass fiber 60 having a core region (1) with outer radius r₁ and relative refractive index Δ₁ with maximum relative refractive index Δ₁ₘₐₓ, an offset cladding region (2) extending from radial position r₁ to radial position r₂>r₁ and having relative refractive index Δ₂, a trench cladding region (3) extending from radial position r₂ to radial position r₃ and having relative refractive index Δ₃, and an outer cladding region (4) extending from radial position r₃ to radial position r₄ and having relative refractive index Δ₄. In the embodiment of FIG. 5B, relative refractive index Δ₃ is constant or approximately constant from inner radius r₂ of the trench cladding region (3) to the outer radius r₃ of the trench cladding region (3).

FIG. 5C shows a graded index profile for a glass fiber 60 having a core region (1) with outer radius r₁ and relative refractive index Δ₁ with maximum relative refractive index Δ₁ₘₐₓ, a trench cladding region (3) extending from radial position r₂=r₁ to radial position r₃ and having relative refractive index Δ₃, and an outer cladding region (4) extending from radial position r₃ to radial position r₄ and having relative refractive index Δ₄. In the embodiment of FIG. 5C, relative refractive index Δ₃ is monotonically decreasing with a constant or approximately constant slope from a maximum value Δ₃ₘₐₓ at inner radius r₂ of the trench cladding region (3) to a minimum value Δ₃ₘᵢₙ at the outer radius r₃ of the trench cladding region (3). FIG. 5C is an example of a trench cladding region in which the relative refractive index Δ₃ continuously varies between the inner radius r₂ of the trench cladding region (3) and the outer radius r₃ of the trench cladding region (3). FIG. 5C is also an example of a trench cladding region in which the radial position of the minimum value Δ₃ₘᵢₙ is closer to the outer radius r₃ of the trench cladding region (3) than it is to the inner radius r₂ of the trench cladding region (3).

FIG. 5D shows a graded index profile for a glass fiber 60 having a core region (1) with outer radius r₁ and relative refractive index Δ₁ with maximum relative refractive index Δ₁ₘₐₓ, an offset cladding region (2) extending from radial position r₁ to radial position r₂>r₁ and having relative refractive index Δ₂, a trench cladding region (3) extending from radial position r₂ to radial position r₃ and having relative refractive index Δ₃, and an outer cladding region (4) extending from radial position r₃ to radial position r₄ and having relative refractive index Δ₄. In the embodiment of FIG. 5D, relative refractive index Δ₃ is monotonically decreasing with a constant or approximately constant slope from a maximum value Δ₃ₘₐₓ at inner radius r₂ of the trench cladding region (3) to a minimum value Δ₃ₘᵢₙ at the outer radius r₃ of the trench cladding region (3).

In the profiles of FIGS. 5A and 5B, the trench cladding region (3) has a constant or average relative refractive index Δ₃ that is less than the relative refractive index Δ₄ of the outer cladding region (4). In the profiles of FIGS. 5C and 5D, the trench cladding region (3) has a minimum relative refractive index Δ₃ₘᵢₙ that is less than the relative refractive index Δ₄ of the outer cladding region (4). Core region (1) has the highest average and highest maximum relative refractive index in the profile. Core region (1) may include a lower index region at or near the centerline (known in the art as a “centerline dip”) (not shown).

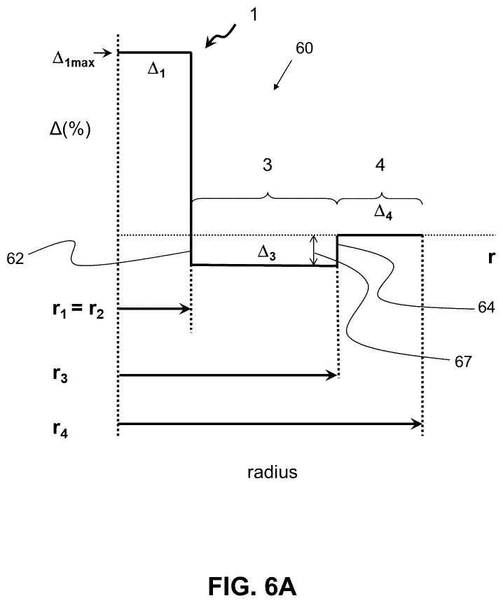

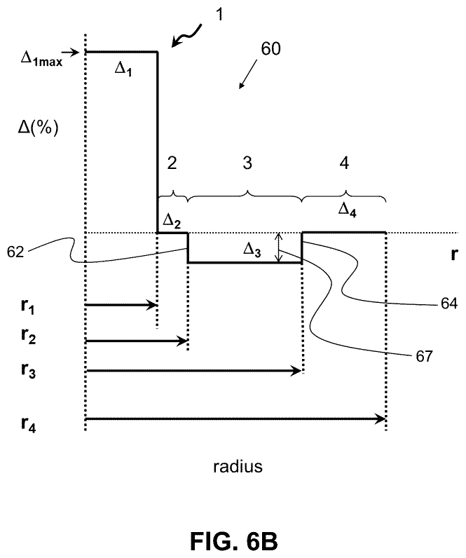

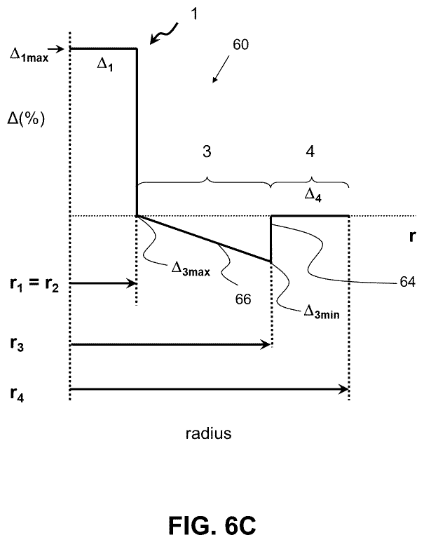

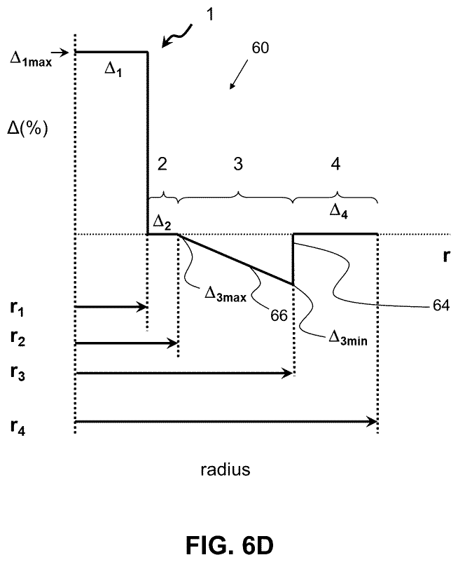

In the embodiments shown in FIGS. 5A-5D, the core region (1) of the glass fiber has a relative refractive index described by an α-profile. The radial position r₀ (corresponding to Δ₁ₘₐₓ) of the α-profile corresponds to the centerline (r=0) of the fiber and the radial position r_{z} of the α-profile corresponds to the core radius r₁. In embodiments with a centerline dip, the radial position r₀ is slightly offset from the centerline of the fiber (not shown). In other embodiments, core region (1) shown in FIGS. 5A-5D is a step index relative refractive index profile instead of an α-profile (see FIGS. 6A-6D). In still other embodiments, core region (1) has a relative refractive index profile not defined by any of an α-profile or a step-index profile. In some embodiments, the relative refractive index Δ₁ continuously decreases in the radial direction away from the centerline. In other embodiments, relative refractive index Δ₁ varies over some radial positions between the centerline and r₁, and also includes a constant or approximately constant value over other radial positions between the centerline and r₁.

In FIGS. 5A and 6A, transition region 62 from core region (1) to trench cladding region (3) and transition region 64 from trench cladding region (3) to outer cladding region (4) are shown as step changes. In FIGS. 5B and 6B, transition region 62 from offset cladding region (2) to trench cladding region (3) and transition region 64 from trench cladding region (3) to outer cladding region (4) are shown as step changes. In FIGS. 5C, 5D, 6C, and 6D, transition region 64 from trench cladding region (3) to outer cladding region (4) are shown as step changes. It is to be understood that a step change is an idealization and that transition region 62 and transition region 64 may not be strictly vertical in practice. Instead, transition region 62 and/or transition region 64 may have a slope or curvature. When transition region 62 and/or transition region 64 are non-vertical, the inner radius (r₂) and outer radius (r₃) of trench cladding region (3) correspond to the mid-points of transition regions 62 and 64, respectively. The mid-points correspond to half of the depth 67 (FIGS. 5A, 5B, 6A, and 6B) or half the depth of the minimum relative refractive index Δ₃ₘᵢₙ (FIGS. 5C, 5D 6C, and 6D) of the trench cladding region (3), where depth 67 or the depth of the minimum relative refractive index Δ₃ₘᵢₙ is defined relative to relative refractive index Δ₄ of the outer cladding region (4).

The relative ordering of relative refractive indices Δᵢ, Δ₃, and Δ₄ in the relative refractive index profile shown in FIGS. 5A, 5B, 6A, and 6B satisfy the condition Δ₁ₘₐₓ>Δ₄>Δ₃. The relative ordering of relative refractive indices Δ₁, Δ₃ₘᵢₙ, and Δ₄ in the relative refractive index profile shown in FIGS. 5C, 5D, 6C, and 6D satisfy the condition Δ₁ₘₐₓ>Δ₄>Δ₃ min.

The core region comprises silica glass. The silica glass of the core region is undoped silica glass, updoped silica glass, and/or downdoped silica glass. In one embodiment, the silica glass of the core region is Ge-free; that is the core region comprises silica glass that lacks Ge. In another embodiment, the core region comprises silica glass doped with germanium dioxide (GeO₂). Embodiments of updoped silica glass include silica glass doped with an alkali metal oxide (e.g. Na₂O, K₂O, Li₂O, Cs₂O, or Rb₂O) and/or a halogen (Cl or Br). Downdoped silica glass includes silica glass doped with F. In a preferred embodiment, the core region comprises Ge-doped silica glass.

In some embodiments, the relative refractive index of the core region of the glass fiber is described by an α-profile with an α value in the range from 1.5 to 10, or in the range from 1.7 to 8.0, or in the range from 1.8 to 6.0, or in the range from 1.9 to 5.0, or in the range from 1.95 to 4.5, or in the range from 2.0 to 4.0, or in the range from 10 to 100, or in the range from 11 to 40, or in the range from 12 to 30. As the value of a increases, the relative refractive profile more closely approaches a step index profile. For purposes of the present disclosure, an α-profile with an α value greater than or equal to 10 is regarded as a step index profile.

The outer radius r₁ of the core region is in the range from 2.5 μm to 6.0 μm, or in the range from 3.0 μm to 5.5 μm, or in the range from 3.5 μm to 5.0 μm. In embodiments without an offset cladding region, the inner radius of the trench cladding region is r₂=r₁ and has the values listed for r₁ above.

The relative refractive index Δ₁ or Δ₁ₘₐₓ of the core region is in the range from 0.30% to 0.60%, or in the range from 0.35% to 0.55%, or in the range from 0.40% to 0.50%. The minimum relative refractive index Δ₁ₘᵢₙ of the core region is in the range from −0.10% to 0.10%, or in the range from −0.05% to 0.05%, or in the range from −0.02% to 0.02%.

In some embodiments, the relative refractive index of the core region is described by a step-index profile having a constant or approximately constant value corresponding to Δ₁ₘₐₓ that extends over at least 70%, or at least 80%, or at least 90% of the distance between the centerline of the optical fiber (r=0) and the outer radius rᵢ.

In some embodiments, the cladding includes an offset cladding region directly adjacent the core region and a trench cladding region directly adjacent the offset cladding region. In these embodiments, the offset cladding region has an inner radius r₁ as defined above and an outer radius r₂>rᵢ. In these embodiments, the outer radius r₂ of the offset cladding region is in the range from 5.0 μm to 12.0 μm, or in the range from 5.5 μm to 11.0 μm, or in the range from 6.0 μm to 10.0 μm. The thickness r₂−r₁ of the offset cladding region is in the range from 1.0 μm to 8.0 μm, or in the range from 1.5 μm to 7.0 μm, or in the range from 2.0 μm to 6.0 μm, or in the range from 2.0 μm to 5.0 μm. The relative refractive index Δ₂ of the offset cladding region is in the range from −0.10% to 0.10%, or in the range from −0.05% to 0.05%, or in the range from −0.02% to 0.02%.

The trench cladding region comprises downdoped silica glass. The preferred downdopant is F (fluorine). The relative refractive index Δ₃ or Δ₃ₘᵢₙ of the trench cladding region is greater than or equal to −0.70% and/or less than or equal to −0.10%, or greater than or equal to −0.65% and/or less than or equal to −0.15%, or greater than or equal to −0.60% and/or less than or equal to −0.20%, or greater than or equal to −0.55% and/or less than or equal to −0.25%, or greater than or equal to −0.50% and/or less than or equal to −0.30%, or in the range from −0.10% to −0.70%, or in the range from −0.15% to −0.70%, or in the range from −0.15% to −0.55%, or in the range from −0.20% to −0.50% or in the range from −0.25% to −0.45%, or in the range from −0.30% to −0.60%. In some embodiments, the relative refractive index Δ₃ is constant or approximately constant, and in other embodiments, the relative refractive index Δ₃ varies continuously or decreases monotonically from inner radius r₂ to outer radius r₃. In a preferred embodiment, the monotonic decrease in Δ₃ exhibits a constant or approximately constant slope. In such embodiments, the trench cladding region is referred to herein as a triangular trench. The monotonic decrease in Δ₃ extends from a maximum value Δ₃ₘₐₓ at or near inner radius r₂ to a minimum value Δ₃ₘᵢₙ at or near outer radius r₃. The relative refractive index Δ₃ₘₐₓ is in the range from −0.10% to 0.10%, or in the range from −0.05% to 0.05%, or in the range from −0.02% to 0.02%. In one embodiment, relative refractive index Δ₃ₘₐₓ is equal or approximately equal to the relative refractive index Δᵢₘᵢₙ. In another embodiment, the relative refractive index Δ₃ₘₐₓ is equal or approximately equal to the relative refractive index Δ₂. The relative refractive index Δ₃ₘᵢₙ is in the range from −0.15% to −0.70%, or in the range from −0.20% to −0.70%, or in the range from −0.25% to −0.65%, or in the range from −0.30% to −0.60%, or in the range from −0.30% to −0.50% or in the range from −0.35% to −0.45%.

The inner radius r₂ of the trench cladding region is r₂=r₁ (in embodiments without an offset cladding region) or r₂>r₁ (in embodiments with an offset cladding region) and has the values specified above. The outer radius r₃ of the trench cladding region is in the range from 12.0 μm to 20.0 μm, or in the range from 12.5 μm to 18.0 μm, or in the range from 13.0 μm to 17.0 μm, or in the range from 13.5 μm to 16.5 μm. The thickness r₃−r₂ of the trench cladding region is in the range from 3.0 μm to 12.0 μm, or in the range from 5.0 μm to 11.0 μm, or in the range from 6.0 μm to 10.0 μm.

The trench cladding region has a trench volume greater than or equal to 30% μm², or greater than or equal to 35% μm², or greater than or equal to 40% μm², or greater than or equal to 45% μm², or greater than or equal to 50% μm², or greater than or equal to 55% μm², or in the range from 30% μm² to 60% μm², or in the range from 35% μm² to 55% μm², or in the range from 40% μm² to 50% μm². Trench volume can be controlled by varying the thickness r₃−r₂ of the trench cladding region, the relative refractive index (Δ₃, Δ₃ₘᵢₙ, and/or Δ₃ₘₐₓ) of the trench cladding region and/or the difference between the relative refractive index of the outer cladding region (Δ₄) and the relative refractive index of the trench cladding region (Δ₃, Δ₃ₘᵢₙ, and/or Δ₃ₘₐₓ).

The relative refractive index Δ₄ or Δ₄ₘₐₓ of the outer cladding region is in the range from −0.10% to 0.10%, or in the range from −0.05% to 0.05%, or in the range from −0.02% to 0.02%. The relative refractive index Δ₄ is preferably constant or approximately constant.

The inner radius of the outer cladding region is r₃ and has the values specified above. The outer radius r₄ of the outer cladding region is in the range from 38.0 μm to 63.0 μm, or in the range from 40.0 μm to 62.5 μm, or in the range from 50.0 μm to 62.5 μm, or in the range from 52.5 μm to 61.0 μm, or in the range from 55.0 μm to 60.0 μm, or in the range from 57.5 μm to 59.0.0 μm, or in the range from 60.0 μm to 63.0 μm, or in the range from 61.0 μm to 63.0 μm, or in the range from 62.0 μm to 63.0 μm, or about 62.5 μm. The thickness r₄−r₃ of the outer cladding region is in the range from 25.0 μm to 50.0 μm, or in the range from 30.0 μm to 45.0 μm, or in the range from 35.0 μm to 40.0 μm.

Optical Fiber Coatings. The transmissivity of light through an optical fiber is dependent on the properties of the coatings applied to the glass fiber. The coatings typically include a primary coating and a secondary coating, where the secondary coating surrounds and directly contacts the primary coating and the primary coating surrounds and directly contacts the glass fiber. The secondary coating is a harder material (higher in situ modulus (e.g. greater than 1200 MPa) than the primary coating and is designed to protect the glass fiber from damage caused by abrasion or external forces that arise during processing, handling, and installation of the optical fiber. The primary coating is a softer material (lower in situ modulus (e.g. less than 1 MPa) than the secondary coating and is designed to buffer or dissipates stresses that result from forces applied to the outer surface of the secondary coating. Dissipation of stresses within the primary coating attenuates the stress and minimizes the stress that reaches the glass fiber. The primary coating is especially important in dissipating stresses that arise due to the microbends that the optical fiber encounters when deployed in a cable. The microbending stresses transmitted to the glass fiber need to be minimized because microbending stresses create local perturbations in the refractive index profile of the glass fiber. The local refractive index perturbations lead to intensity losses for the light transmitted through the glass fiber. By dissipating stresses, the primary coating minimizes microbend-induced intensity losses.

The primary coating 16 preferably has a higher refractive index than the cladding region of the glass fiber in order to allow it to strip errant optical signals away from the core region. The primary coating should maintain adequate adhesion to the glass fiber during thermal and hydrolytic aging, yet be strippable from the glass fiber for splicing purposes.

Primary and secondary coatings are typically formed by applying a curable coating composition to the glass fiber as a viscous liquid and curing. The optical fiber may also include a tertiary coating (not shown) that surrounds the secondary coating. The tertiary coating may include pigments, inks or other coloring agents to mark the optical fiber for identification purposes and typically has an in situ modulus similar to the in situ modulus of the secondary coating.

Primary Coating Compositions. The primary coating is a cured product of a curable primary coating composition. The curable primary coating compositions provide a primary coating for optical fibers that exhibits low in situ modulus, low pullout force, and strong cohesion. The curable primary coating compositions further enable formation of a primary coating that features clean strippability and high resistance to defect formation during the stripping operation. Low pullout force facilitates clean stripping of the primary coating with minimal residue and strong cohesion inhibits initiation and propagation of defects in the primary coating when it is subjected to stripping forces.

The primary coating is a cured product of a radiation-curable primary coating composition that includes an oligomer, a monomer, a photoinitiator and, optionally, an additive. The following disclosure describes oligomers for the radiation-curable primary coating compositions, radiation-curable primary coating compositions containing at least one of the oligomers, cured products of the radiation-curable primary coating compositions that include at least one of the oligomers, glass fibers coated with a radiation-curable primary coating composition containing at least one of the oligomers, and glass fibers coated with the cured product of a radiation-curable primary coating composition containing at least one of the oligomers.

The oligomer preferably includes a polyether urethane diacrylate compound or a combination of a polyether urethane diacrylate compound and a di-adduct compound. In one embodiment, the polyether urethane diacrylate compound has a linear molecular structure. In one embodiment, the oligomer is formed from a reaction between a diisocyanate compound, a polyol compound, and a hydroxy acrylate compound, where the reaction produces a polyether urethane diacrylate compound as a primary product (majority product) and a di-adduct compound as a byproduct (minority product). The reaction forms a urethane linkage upon reaction of an isocyanate group of the diisocyanate compound and an alcohol group of the polyol. The hydroxy acrylate compound reacts to quench residual isocyanate groups that are present in the composition formed from reaction of the diisocyanate compound and polyol compound. As used herein, the term “quench” refers to conversion of isocyanate groups through a chemical reaction with hydroxyl groups of the hydroxy acrylate compound. Quenching of residual isocyanate groups with a hydroxy acrylate compound converts terminal isocyanate groups to terminal acrylate groups.

The diisocyanate compound, hydroxy acrylate compound and polyol are combined simultaneously and reacted, or are combined sequentially (in any order) and reacted. In one embodiment, the oligomer is formed by reacting a diisocyanate compound with a hydroxy acrylate compound and reacting the resulting product composition with a polyol. In another embodiment, the oligomer is formed by reacting a diisocyanate compound with a polyol compound and reacting the resulting product composition with a hydroxy acrylate compound.

The oligomer is formed from a reaction of a diisocyanate compound, a hydroxy acrylate compound, and a polyol, where the molar ratio of the diisocyanate compound to the hydroxy acrylate compound to the polyol in the reaction process is n:m:p. n, m, and p are referred to herein as mole numbers or molar proportions of diisocyanate, hydroxy acrylate, and polyol; respectively. The mole numbers n, m and p are positive integer or positive non-integer numbers. In embodiments, when p is 2.0, n is in the range from 3.0 to 5.0, or in the range from 3.2 to 4.8, or in the range from 3.4 to 4.6, or in the range from 3.5 to 4.4, or in the range from 3.6 to 4.2, or in the range from 3.7 to 4.0; and m is in the range from 1.5 to 4.0, or in the range from 1.6 to 3.6, or in the range from 1.7 to 3.2, or in the range from 1.8 to 2.8, or in the range from 1.9 to 2.4. For values of p other than 2.0, the molar ratio n:m:p scales proportionally. For example, the molar ratio n:m:p=4.0:3.0:2.0 is equivalent to the molar ratio n:m:p=2.0:1.5:1.0.

The curable primary coating composition further includes one or more monomers. The one or more monomers is/are selected to be compatible with the oligomer, to control the viscosity of the primary coating composition to facilitate processing, and/or to influence the physical or chemical properties of the coating formed as the cured product of the primary coating composition. The monomers include radiation-curable monomers such as ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

Representative radiation-curable ethylenically unsaturated monomers include alkoxylated monomers with one or more acrylate or methacrylate groups. An alkoxylated monomer is one that includes one or more alkoxylene groups, where an alkoxylene group has the form —O—R— and R is a linear or branched alkylene group. Examples of alkoxylene groups include ethoxylene (—O—CH₂—CH₂—), n-propoxylene (—O—CH₂—CH₂—CH₂—), isopropoxylene (—O—CH₂—CH(CH₃)—, or —O—CH(CH₃)—CH₂—), etc. As used herein, the degree of alkoxylation refers to the number of alkoxylene groups in the monomer. In one embodiment, the alkoxylene groups are bonded consecutively in the monomer.

In some embodiments, the primary coating composition includes an alkoxylated monomer of the form R₄—R₅—O—(CH(CH₃)CH₂—O)_{q}—C(O)CH═CH₂, where R₄ and R₅ are aliphatic, aromatic, or a mixture of both, and q=1 to 10, or R₄—O—(CH(CH₃)CH₂—O)_{q}—C(O)CH═CH₂, where C(O) is a carbonyl group, R₁ is aliphatic or aromatic, and q=1 to 10.

In some embodiments, the monomer component of the primary coating composition includes a multifunctional (meth)acrylate. Multifunctional ethylenically unsaturated monomers include multifunctional acrylate monomers and multifunctional methacrylate monomers. Multifunctional acrylates are acrylates having two or more polymerizable acrylate moieties per molecule, or three or more polymerizable acrylate moieties per molecule.

In some embodiments, the primary coating composition includes an N-vinyl amide monomer such as an N-vinyl lactam, or N-vinyl pyrrolidinone, or N-vinyl caprolactam.

In addition to a curable monomer and a curable oligomer, the curable primary coating composition also includes a polymerization initiator. The polymerization initiator facilitates initiation of the polymerization process associated with the curing of the coating composition to form the coating. Polymerization initiators include thermal initiators, chemical initiators, electron beam initiators, and photoinitiators. Photoinitiators include ketonic photoinitiators and/or phosphine oxide photoinitiators. When used in the curing of the coating composition, the photoinitiator is present in an amount sufficient to enable rapid radiation curing.

The curable primary coating composition optionally includes one or more additives. Additives include an adhesion promoter, a strength additive, an antioxidant, a catalyst, a stabilizer, an optical brightener, a property-enhancing additive, an amine synergist, a wax, a lubricant, and/or a slip agent. Some additives operate to control the polymerization process, thereby affecting the physical properties (e.g., modulus, glass transition temperature) of the polymerization product formed from the coating composition. Other additives affect the integrity of the cured product of the primary coating composition (e.g., protect against de-polymerization or oxidative degradation).

To minimize the overall diameter of the coated optical fiber, it is preferable to minimize the thickness r₅−r₄ of the primary coating. In embodiments, the thickness r₅−r₄ of the primary coating is less than or equal to 25.0 μm, or less than or equal to 22.5 μm, or less than or equal to 20.0 μm, or less than or equal to 17.5 μm.

To minimize microbending, preferred primary coatings have an in situ modulus less than or equal to 0.30 MPa, or less than or equal to 0.27 MPa, or less than or equal to 0.25 MPa, or less than or equal to 0.22 MPa, or less than or equal to 0.20 MPa, or less than or equal to 0.15 MPa. Representative suitable primary coating compositions are the DeSolite® COV-DP-1900 and the DeSolite® COV-DP-1032 primary optical fiber coatings that are commercially available from Covestro (Fiber Optic Center, New Bedford, MA).

For primary coatings, the in situ modulus is measured using the following procedure. A six-inch sample of a coated fiber sample is obtained and a one-inch section from the center of the fiber sample is window stripped and wiped with isopropyl alcohol. The window-stripped fiber sample is mounted on a sample holder/alignment stage equipped with 10 mm×5 mm rectangular aluminum tabs that are used to affix the fiber sample. Two tabs are oriented horizontally and positioned so that the short 5 mm sides are facing each other and separated by a 5 mm gap. The window-stripped fiber sample is laid horizontally on the sample holder across the tabs and over the gap separating the tabs. The coated end of one side of the window-stripped region of the fiber sample is positioned on one tab and extends halfway into the 5 mm gap between the tabs. The one-inch window-stripped region extends over the remaining half of the gap and across the opposing tab. After alignment, the fiber sample is moved and a small dot of glue is applied to the half of each tab closest to the 5 mm gap. The fiber sample is then returned to position and the alignment stage is raised until the glue just touches the fiber sample. The coated end is then pulled away from the gap and through the glue such that the majority of the 5 mm gap between the tabs is occupied by the window-stripped region of the fiber sample. The portion of the window-stripped region remaining on the opposing tab is in contact with the glue. The very tip of the coated end is left to extend beyond the tab and into the gap between the tabs. This portion of the coated end is not embedded in the glue and is the object of the in situ modulus measurement. The glue is allowed to dry with the fiber sample in this configuration to affix the fiber sample to the tabs. After drying, the length of fiber sample fixed to each of the tabs is trimmed to 5 mm. The coated length embedded in glue, the non-embedded coated length (the portion extending into the gap between the tabs), and the primary diameter are measured.

The in situ modulus measurements for the primary coatings are performed on a Rheometrics DMTA IV dynamic mechanical testing apparatus at a constant strain of 9×10⁻⁶ l/s for a time of forty-five minutes at room temperature (21° C.). The gauge length is 15 mm. Force and delta length are recorded and used to calculate the in situ modulus of the primary coating. The tab-mounted fiber samples are prepared by removing any epoxy from the tabs that would interfere with the 15 mm clamping length of the testing apparatus to insure that there is no contact of the clamps with the fiber and that the sample is secured squarely to the clamps. The instrument force is zeroed out. The tab to which the non-coated end of the fiber sample is affixed is then mounted to the lower clamp (measurement probe) of the testing apparatus and the tab to which the coated end of the fiber sample is affixed was mounted to the upper (fixed) clamp of the testing apparatus. The test is then executed and the fiber sample is removed once the analysis is completed.

Secondary Coating—Compositions. The secondary coating is a cured product of a curable secondary coating composition that includes a monomer, a photoinitiator, an optional oligomer, and an optional additive. The present disclosure describes optional oligomers for the radiation-curable secondary coating compositions, radiation-curable secondary coating compositions, cured products of the radiation-curable secondary coating compositions, optical fibers coated with a radiation-curable secondary coating composition, and optical fibers coated with the cured product of a radiation-curable secondary coating composition.

The secondary coating is formed as the cured product of a radiation-curable secondary coating composition that includes a monomer component with one or more monomers. The monomers preferably include ethylenically unsaturated compounds. In one embodiment, the secondary coating is the radiation-cured product of a secondary coating composition that contains urethane acrylate monomers.

The monomers include functional groups that are polymerizable groups and/or groups that facilitate or enable crosslinking. The monomers are monofunctional monomers or multifunctional monomers. In combinations of two or more monomers, the constituent monomers are monofunctional monomers, multifunctional monomers, or a combination of monofunctional monomers and multifunctional monomers. In one embodiment, the monomer component of the curable secondary coating composition includes ethylenically unsaturated monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

In one embodiment, the monomer component of the curable secondary coating composition includes ethylenically unsaturated monomers. The monomers include functional groups that are polymerizable groups and/or groups that facilitate or enable crosslinking. The monomers are monofunctional monomers or multifunctional monomers. In combinations of two or more monomers, the constituent monomers are monofunctional monomers, multifunctional monomers, or a combination of monofunctional monomers and multifunctional monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

Representative radiation-curable ethylenically unsaturated monomers included alkoxylated monomers with one or more acrylate or methacrylate groups. An alkoxylated monomer is one that includes one or more alkoxylene groups, where an alkoxylene group has the form —O—R— and R is a linear or branched hydrocarbon. Examples of alkoxylene groups include ethoxylene (—O—CH₂—CH₂—), n-propoxylene (—O—CH₂—CH₂—CH₂—), isopropoxylene (—O—CH₂—CH(CH₃)—), etc. As used herein, the degree of alkoxylation refers to the number of alkoxylene groups in the monomer. In one embodiment, the alkoxylene groups are bonded consecutively in the monomer.

Multifunctional ethylenically unsaturated monomers for the curable secondary coating composition include, without limitation, alkoxylated bisphenol A diacrylates, such as ethoxylated bisphenol A diacrylate, with the degree of alkoxylation being 2 or greater. The monomer component of the secondary coating composition may include ethoxylated bisphenol A diacrylate with a degree of ethoxylation ranging from 2 to about 30 or propoxylated bisphenol A diacrylate with the degree of propoxylation being 2 or greater; for example, ranging from 2 to about 30; methylolpropane polyacrylates with and without alkoxylation such as ethoxylated trimethylolpropane triacrylate with the degree of ethoxylation being 3 or greater.

The curable secondary coating composition also includes a photoinitiator and optionally includes additives such as anti-oxidant(s), optical brightener(s), amine synergist(s), tackifier(s), catalyst(s), a carrier or surfactant, and a stabilizer as described above in connection with the curable primary coating composition.

To minimize the overall diameter of the coated optical fiber, it is preferable to minimize the outer radius r₆ and/or the thickness r₆−r₅ of the secondary coating. In embodiments, the outer radius r₆ of the secondary coating is less than or equal to 85.0 μm, or less than or equal to 82.5 μm, or less than or equal to 80.0 μm, or less than or equal to 77.5 μm, or less than or equal to 75.0 μm, or less than or equal to 72.5 μm, or less than or equal to 70.0 μm. In embodiments, the thickness r₆−r₅ of the secondary coating is less than or equal to 25.0 μm, or less than or equal to 22.5 μm, or less than or equal to 20.0 μm, or less than or equal to 17.5 μm.

To maintain adequate protection of the glass fiber, it is preferable for the secondary coating to have a high in situ modulus. Preferred secondary coatings have an in situ modulus greater than or equal to 1200 MPa, or greater than or equal to 1400 MPa, or greater than or equal to 1600 MPa, greater than or equal to 1800 MPa, or greater than or equal to 2000 MPa, or greater than or equal to 2200 MPa, or greater than or equal to 2400 MPa, or greater than or equal to 2600 MPa, or greater than or equal to 2800 MPa, or greater than or equal to 3000 MPa. Representative suitable secondary coating compositions are the DeSolite® COV-DS-2500 and the DeSolite® COV-DP-2900 secondary optical fiber coatings that are commercially available from Covestro (Fiber Optic Center, New Bedford, MA).

For secondary coatings, the in situ modulus is measured using fiber tube-off samples prepared from the fiber samples. A 0.0055 inch Miller stripper is clamped down approximately 1 inch from the end of the fiber sample. This one-inch region of fiber sample is immersed into a stream of liquid nitrogen and held for 3 seconds. The fiber sample is then removed and quickly stripped. The stripped end of the fiber sample is then inspected. If coating remains on the glass portion of the fiber sample, the tube-off sample is deemed defective and a new tube-off sample is prepared. A proper tube-off sample is one that stripped clean from the glass and consists of a hollow tube with primary and secondary coating. The glass, primary and secondary coating diameter are measured from the end-face of the un-stripped fiber sample.

The fiber tube-off samples are run using a Rheometrics DMTA IV instrument at a sample gauge length 11 mm to obtain the in situ modulus of the secondary coating. The width, thickness, and length are determined and provided as input to the operating software of the instrument. The sample is mounted and run using a time sweep program at ambient temperature (21° C.) using the following parameters:

$$Frequency : 1 Rad / sec$$

$$Strain : 0.3 \%$$

$$Total time = 120 sec .$$

$$Time Per Measurement = 1 sec$$

$$Initial Static Force = 15. g$$

$$Static > Dynamic Force by = 10. \%$$

Once completed, the last five E′ (storage modulus) data points are averaged. Each sample is run three times (fresh sample for each run) for a total of fifteen data points. The averaged value of the three runs is reported.

Optical Fiber Preform. In production, optical fibers are drawn from preforms. The preform is a dense glass monolith with a typical diameter of about 27 cm and a typical length of about 200 cm. The preform includes a central core region surrounded by an annular cladding region. The composition of the core and cladding regions of the preform correspond to the compositions of the core and cladding regions of an optical fiber drawn from the preform. The diameter of the core region of the preform and the thickness of the cladding region of the preform are in proportion to the core diameter and cladding thickness of an optical fiber drawn from the preform. The core region and/or cladding region of the preform may include multiple concentric layers that differ in dopant type or dopant concentration to provide optical fibers having a desired refractive index profile, such as the relative refractive index profiles described herein.

Silica and doped silica for the core and cladding regions of an optical fiber preform can be produced by methods known in the art. Suitable methods include flame combustion methods, flame oxidation methods, flame hydrolysis methods, OVD (outside vapor deposition), IVD (inside vapor deposition), VAD (vapor axial deposition), rod-in-tube procedures, cane-in-soot method, and doped deposited silica processes. A variety of CVD (chemical vapor deposition) and plasma-enhanced CVD processes are known and are suitable for producing silica or doped silica.

Formation of silica occurs through reaction or decomposition of a silica precursor. Suitable precursors for silica include OMCTS (octamethylcyclotetrasiloxane) and SiCl₄. Doping is accomplished with a doping precursor. The doping precursor can be introduced with the silica precursor in the deposition process or used to treat a silica body formed from the silica precursor. The increase in the refractive index of the core region is achieved by doping the core region with a dopant that increases the index. The dopants in the core increasing the index include germania (GeO₂), titania (TiO₂), phosphorus (P₂O₅), chlorine, among others. Core dopants can be incorporated by flowing the dopant precursors such as germanium tetrachloride (GeCl₄), titania tetrachloride (TiCl₄), phosphorus oxychloride (POCl₃) among others in the burner along with the silica precursors during the core making step of the soot preform deposition process. Halogens are doped by treating the soot preform during the consolidation and sintering of the preform. Suitable precursors for doping silica with chlorine include Cl₂, SiCl₄, Si₂Cl₆, Si₂OCl₆, and CCl₄. Suitable precursors for doping silica with fluorine include F₂, CF₄, and SiF₄. Doping of silica with fluorine is done to lower of the refractive index and make the trench portions of the preforms. The silica precursor and/or doping precursor is preferably provided as a gas to the deposition process. The gas phase silica precursor or gas phase doping precursor is supplied undiluted or in combination with an inert diluent gas (e.g. He, N₂, Ar).

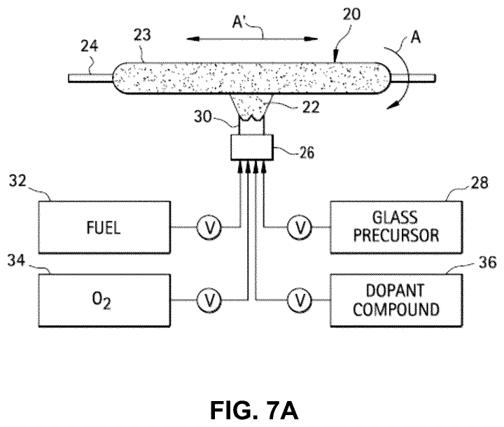

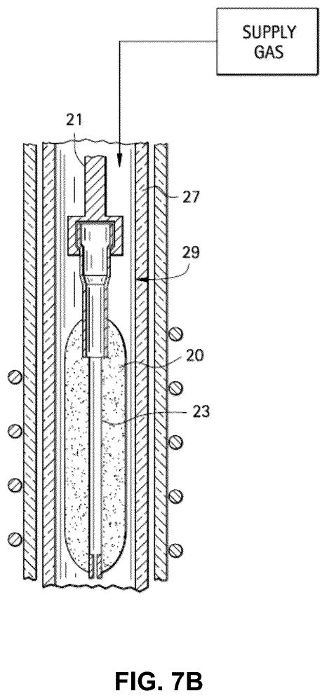

The preform is made by forming the core region and cladding regions in one or more process steps. Typical process steps include soot deposition, doping, and consolidation. By way of illustration and not intended to be limiting, formation of a silica or doped silica in the form of a core soot body according to the OVD method is illustrated in FIGS. 7A and 7B. In FIG. 7A, core soot body 20 is formed by depositing silica-containing soot 22 onto the outer surface of a rotating and translating mandrel 24. Mandrel 24 is preferably tapered. The soot 22 for core soot body 20 is formed by providing a glass/soot precursor 28 in gaseous form to the flame 30 of a burner 26 to oxidize, hydrolyze, combust, or otherwise react or decompose it. Fuel 32, such as methane (CH₄), and a combustion supporting gas 34, such as oxygen, are provided to the burner 26 and ignited to form the flame 30. A dopant compound 36 is also optionally provided to the burner 26. Mass flow controllers, labelled V, meter the appropriate amounts of glass/soot precursor 28, fuel 32, combustion supporting gas 34, and dopant compound 36, all preferably in gaseous form, to the burner 26. The glass/soot precursor 28 is a glass former compound (e.g. silica precursor) and is oxidized in the flame 30 to form a generally cylindrical core soot region 23.

FIG. 7B illustrates another process for doping core soot body 20. Prior to consolidation, the bait rod 24 illustrated in FIG. 6A is removed to form a hollow, cylindrical core soot body. During the doping and consolidation process, the core soot body 20 is suspended, for example, inside a pure quartz muffle tube 27 of the furnace 29 by a holding mechanism 21. Prior to or during the consolidation step, the core soot body 20 is optionally exposed to a doping precursor. The doping precursor is preferably provided in gas-phase form and is supplied directly to core soot body 20 before or during consolidation. In one embodiment, the gas-phase doping precursor is a vapor formed by heating or evaporating a liquid precursor. The doping precursor is supplied neat (undiluted) or in combination with a diluent gas. The doping concentration can be controlled by controlling, without limitation, the temperature of doping, the temperature of vaporization of a liquid doping precursor, the pressure or partial pressure of a gas-phase doping precursor in the processing ambient of the core soot body, time of doping, number of doping cycles, and the porosity or surface area of the core soot body (high porosity and/or high surface area promote higher doping concentrations).

In one embodiment after doping, the core soot body is consolidated to form densified glass with the composition and refractive index profile of the core of the optical fiber. Typical temperatures of consolidation are in the range from 1100° C. to 1600° C. The densified glass has a density of at least 1.90 g/cm³. After densification, the densified core glass is optionally redrawn to desired dimensions and is used as a substrate for depositing additional concentric soot layers having the composition and relative refractive index of the cladding regions. Alternatively, the additional concentric soot cladding layers can be deposited on the core soot body before consolidation and the combination of layers can be consolidated to form a preform.

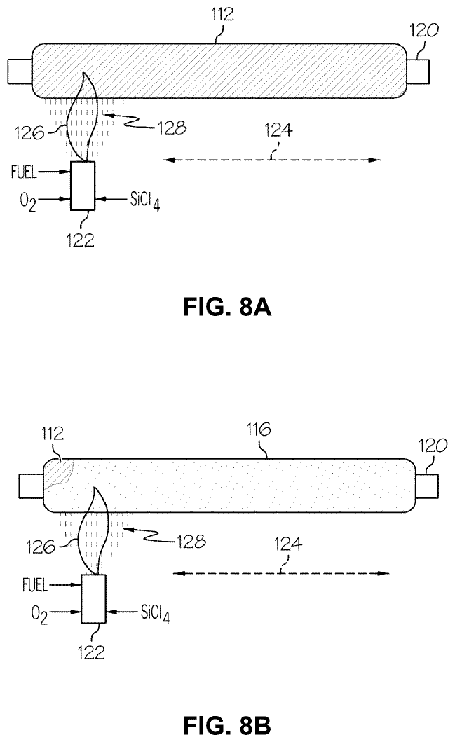

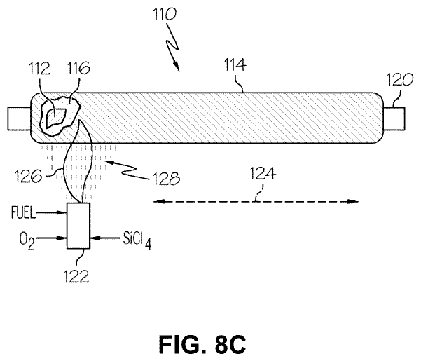

FIGS. 8A-8C illustrate fabrication of a soot body having three porous soot layers. It is recognized, however, that the procedure outlined is generally applicable to a soot bodies having any number of porous soot layers.

FIG. 8A illustrates deposition of a silica-based soot layer 112 on substrate 120. The silica-based glass soot is formed by providing a vapor phase silica-based glass precursor material, such as SiCl₄ or octamethylcyclotetrasiloxane (OMCTS), to a burner 122. The gas-fed burner 122 is supplied with fuel, such as H₂, CH₄, D₂ (deuterium), CD₄ or CO. Oxygen is also provided to burner 122 and the fuel and oxygen are combusted to create flame 126. In some embodiments, the vapor phase silica-based glass precursor material is SiCl₄ and the gas-fed burner 122 is supplied with a non-hydrogenated fuel such as D₂, CD₄ or CO in order to limit the amount of residual OH in the deposited silica-based glass soot. The vapor phase silica-based glass precursor material may be delivered to the burner at a flow rate from about 4 L/min to about 10 L/min, while the fuel may be supplied to the burner at a flow rate from about 10 L/min to about 40 L/min.

The vapor phase silica-based glass precursor material is reacted in the flame 126 to produce silica-based glass soot 128, which is deposited as soot layer 112 on substrate 120 as the bait rod is rotated. The rotation rate may be from about 20 rpm to about 400 rpm, or preferably from 30 rpm to about 100 rpm. Soot layer 112 may have the same, higher, or lower refractive index than undoped silica. Higher or lower refractive indices may be achieved by supplying an updopant or downdopant precursor to burner 122. Soot layer 112 may constitute a single-layer soot cladding monolith or may constitute the innermost (smallest radius) layer of a multilayer soot cladding monolith. The flame 126 of the gas-fed burner 122 is traversed back and forth along the axial length of the substrate 120 as indicated by arrow 124 as the bait rod is rotated thereby building up silica-based glass soot and forming soot layer 112 on the substrate 120.

FIG. 8B depicts deposition of soot layer 116 on soot layer 112. Soot layer 116 may be formed in a similar manner as soot layer 112. For example, a vapor phase silica-based glass precursor material, such as SiCl₄ or OMCTS, and index increasing dopant precursor material, such as GeCl₄ or TiCl₄ or POCl₃, may be supplied to the gas-fed burner 122 and reacted in the flame 126 to form silica-based glass soot and doped glass soot which is deposited as soot layer 116 on soot layer 112 as the bait rod is rotated. Soot layer 116 may have the same, higher, or lower refractive index than soot layer 112.

FIG. 8C depicts deposition of soot layer 114 on soot layer 116. Soot layer 114 may be formed in a similar manner as soot layer 112 or soot layer 116. For example, a vapor phase silica-based glass precursor material, such as SiCl₄ or OMCTS, and index increasing dopant precursor material, such as GeCl₄ or TiCl₄ or POCl₃, may be supplied to the gas-fed burner 122 and reacted in the flame 126 to form silica-based glass soot and doped glass soot which is deposited as soot layer 114 on soot layer 116 as the substrate 120 is rotated. Soot layer 114 may have the same, higher, or lower refractive index than soot layer 116 or soot layer 112. Additional layers of may be deposited similarly to obtain a soot body having any desired number of layers. After deposition of the soot layers, the soot body is consolidated to form a preform.

Process conditions used to form the different layers of a multilayer soot body may be the same or different. Process variables include flame temperature, flow rates of precursors for silicon or dopants, traversal rate of the burner along the length of the substrate, and rotation rate of the substrate. The dopant concentration can be controlled by varying the flow rate of the dopant precursor, selection of dopant precursor, and temperature of doping. Dopant concentration distributions that are uniform or variable in the radial direction are achievable. To form a trench cladding region with a relative refractive index that decreases monotonically in the radial direction, the concentration of downdoping precursor (e.g. SiF₄) is progressively increased during deposition of the trench cladding layer during soot deposition as the concentric monolayers of trench cladding soot are formed. Alternatively, the trench cladding region can be formed by exposing a soot layer to a downdoping precursor (e.g., SiF₄) during a consolidation step. The downdoping precursor is introduced to the outer surface of the soot layer. The downdoping precursor diffuses and reacts with the soot layer to form downdoped soot. As consolidation occurs, the soot layer densifies and diffusion of the downdopant is inhibited. This is one strategy for forming trench cladding regions with a radially varying concentration of downdopant (e.g., a triangular trench cladding region). Further discussion of forming trench cladding regions with a monotonically decreasing relative refractive index is given in U.S. Pat. No. 9,975,802, U.S. Publication No. 20020073740, and Tandon, P., J. Non-Crystalline Solids 351, 1466 (2005), the disclosures of which are hereby incorporated by reference herein. The flow of downdoping precursor is terminated at the transition from the soot layer corresponding to the trench cladding region to the soot layer corresponding to the outer cladding region. Alternatively, the trench cladding region is consolidated and a soot layer corresponding to the outer cladding region is deposited thereon and then consolidated. Variations in process conditions can control the deposition rate of soot and density of soot in the as-deposited state. The flame temperature may be 1500° C. or higher. Higher flame temperatures promote higher as-deposited soot density. Conversely, lower flame temperatures lower as-deposited soot density.

In one embodiment, substrate 120 is a consolidated glass having the composition and refractive index of the core region of the optical fiber to be drawn from the preform. In this embodiment, the soot layers 112, 116, and 114 correspond to different portions of the cladding region (e.g. offset cladding region, trench cladding region, and outer cladding region). In another embodiment, substrate 120 is a bait rod, soot layer 112 corresponds to the core region, and soot layers 116 and 114 correspond to two different portions of the cladding region (e.g. trench cladding region and outer cladding region). The soot layers, when consolidated, provide a preform configured to permit drawing of optical fibers having the relative refractive index profiles disclosed herein.

Optical Fiber Draw Process. In a continuous optical fiber manufacturing process, a glass fiber is drawn from a heated preform and sized to a target diameter (e.g., 125 μm, corresponding to an outer radius r₄=62.5 μm for the glass fiber). The glass fiber is then cooled and directed to a coating system that applies a liquid primary coating composition to the glass fiber. Two process options are viable after application of the liquid primary coating composition to the glass fiber. In one process option (wet-on-dry process), the liquid primary coating composition is cured to form a solidified primary coating, the liquid secondary coating composition is applied to the cured primary coating, and the liquid secondary coating composition is cured to form a solidified secondary coating. In a second process option (wet-on-wet process), the liquid secondary coating composition is applied to the liquid primary coating composition, and both liquid coating compositions are cured simultaneously to provide solidified primary and secondary coatings. After the fiber exits the coating system, the fiber is collected and stored at room temperature. Collection of the fiber typically entails winding the fiber on a spool and storing the spool.

In some processes, the coating system further applies a tertiary coating composition to the secondary coating and cures the tertiary coating composition to form a solidified tertiary coating. Typically, the tertiary coating is an ink layer used to mark the fiber for identification purposes and has a composition that includes a pigment and is otherwise similar to the secondary coating. The tertiary coating is applied to the secondary coating and cured. The secondary coating has typically been cured at the time of application of the tertiary coating. The primary, secondary, and tertiary coating compositions can be applied and cured in a common continuous manufacturing process. Alternatively, the primary and secondary coating compositions are applied and cured in a common continuous manufacturing process, the coated fiber is collected, and the tertiary coating composition is applied and cured in a separate offline process to form the tertiary coating.

The wavelength of curing radiation is infrared, visible, or ultraviolet (UV). Representative wavelengths include wavelengths in the range from 250 nm to 1000 nm, or in the range from 250 nm to 700 nm, or in the range from 250 nm to 450 nm, or in the range from 275 nm to 425 nm, or in the range from 300 nm to 400 nm, or in the range from 320 nm to 390 nm, or in the range from 330 nm to 380 nm, or in the range from 340 nm to 370 nm. Curing can be accomplished with light sources that include a lamp source (e.g. Hg lamp), an LED source (e.g. a UVLED, visible LED, or infrared LED), or a laser source.

Each of the primary, secondary, and tertiary compositions are curable with any of the wavelengths and any of the light sources referred to above. The same wavelength or source can be used to cure each of the primary, secondary, and tertiary compositions, or different wavelengths and/or different sources can be used to cure the primary, secondary, and tertiary compositions. Curing of the primary, secondary, and tertiary compositions can be accomplished with a single wavelength or a combination of two or more wavelengths.

To improve process efficiency, it is desirable to increase the draw speed of the fiber along the process pathway extending from the preform to the collection point. As the draw speed increases, however, the cure speed of coating compositions must increase. The coating compositions disclosed herein are compatible with fiber draw processes that operate at a draw speed greater than or equal to 35 m/s, or greater than or equal to 40 m/s, or greater than or equal to 45 m/s, or greater than or equal to 50 m/s, or greater than or equal to 55 m/s, or greater than or equal to 60 m/s, or greater than or equal to 65 m/s, or greater than or equal to 70 m/s.

### EXAMPLES

Microbend Sensitivity. The transmission of optical signals in optical fibers is sensitive to microbending. As noted above, microbending leads to losses in the intensity of the optical signal, which makes it more difficult to transmit optical signals over large distances in cables. It is accordingly desirable to minimize the sensitivity of optical fibers to microbending. Microbending losses are characterized by a Microbending Sensitivity Parameter, which provides a measure of microbending loss for optical fibers having different coating configurations relative to a reference configuration.

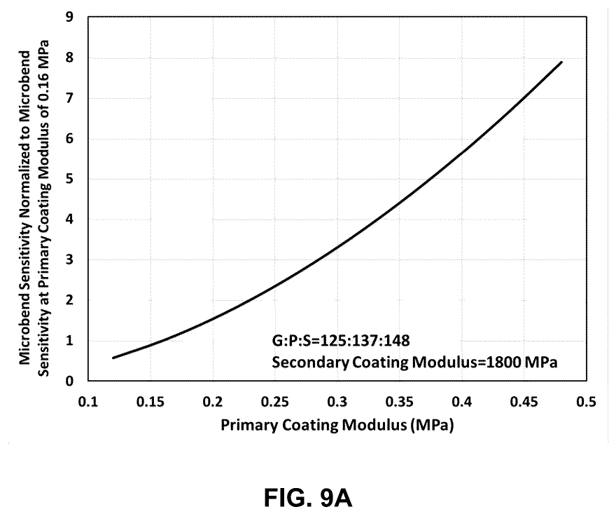

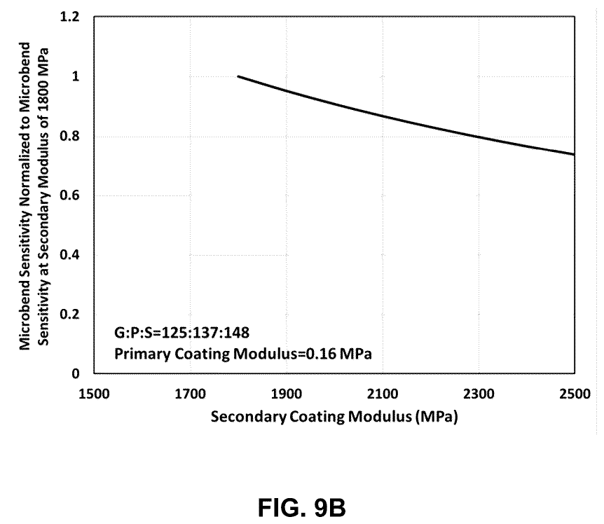

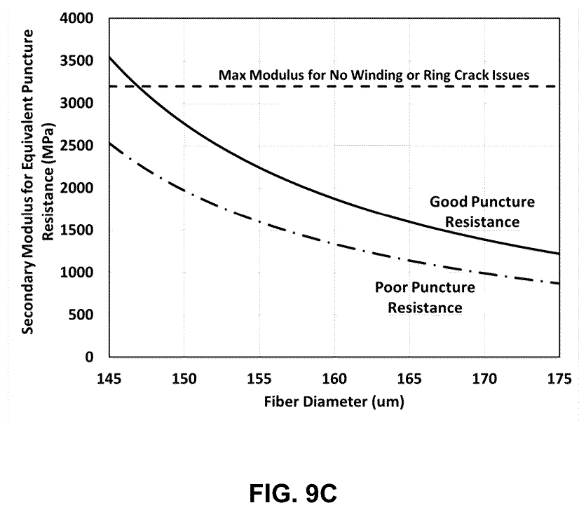

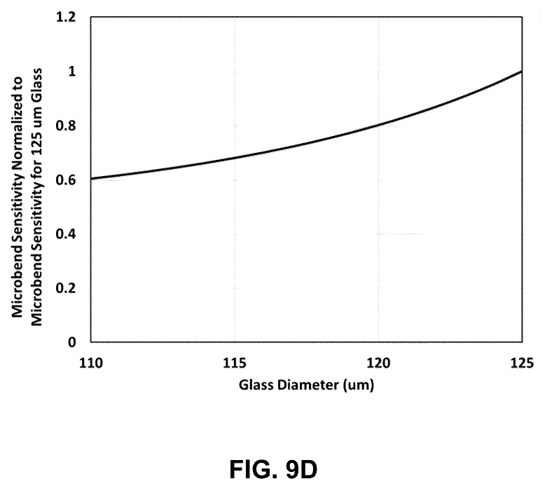

The microbend sensitivity parameter varies with the in situ modulus of the primary and secondary coatings of the optical fiber. To minimize losses due to microbending, it is desirable to configure the optical fiber to minimize the Microbending Sensitivity Parameter. FIG. 9A illustrates the variation in the Microbending Sensitivity Parameter with the in situ modulus of the primary coating for a representative optical fiber that includes a silica glass fiber with an outer radius r₄=62.5 μm, a primary coating outer radius r₅=68.5 μm, a secondary coating outer radius r₆=74 μm. For purposes of FIG. 9A, the in situ modulus of the secondary and tertiary coatings were set at 1800 MPa. FIG. 9A indicates that the Microbend Sensitivity Parameter decreases with decreasing in situ modulus of the primary coating.

FIG. 9B illustrates the variation in the Microbending Sensitivity Parameter with the in situ modulus of the secondary coating for a representative optical fiber that includes a silica glass fiber with an outer radius r₄=62.5 μm, an outer primary coating radius r₅=68.5 μm, an outer secondary coating radius r₆=74 μm. For purposes of FIG. 9B, the in situ modulus of the primary coating was set at 0.45 MPa and the in situ modulus of the tertiary coating was set at 1800 MPa. FIG. 9B indicates that the Microbend Sensitivity Parameter decreases with increasing in situ modulus of the secondary coating.

Further, as the thickness of the secondary coating decreases, the puncture resistance of the optical fiber is negatively impacted. To compensate for the reduction in secondary coating cross-sectional area as the thickness of the secondary coating decreases and yet have good puncture resistance performance, a secondary coating with a higher in situ modulus is required. FIG. 9C shows the in situ modulus of the secondary coating that result in good puncture resistance performance for different diameters (2R₆) of the secondary coating. The data shown in FIG. 9C is for an optical fiber with a glass fiber having a diameter 2r₄ of 125.0 μm, a primary coating having an in situ modulus of 0.16 MPa. and a 1:1 ratio of the thickness r₆−r₅ of secondary coating to thickness r₅−r₄ of primary coating.

Based on the results depicted in FIGS. 9A-9C, it is preferable to configure the optical fiber with a primary coating having a low in situ modulus and a secondary coating having a high in situ modulus. Embodiments for suitable in situ moduli of the primary and secondary coatings are disclosed above.

In some embodiments, the diameter 2R₄ of the glass fiber is reduced to less than 125 μm. A reduction in glass diameter for the same coated fiber diameter (2R₆) results in thicker primary and secondary coating layers. The thicker coating layers not only mitigates coating concentricity, fiber break, and puncture resistance issues, but also improves the microbend sensitivity of the optical fiber. FIG. 9D shows the microbending sensitivity (normalized to 2r₄=125 μm) as a function of glass diameter 2r₄ for an optical fiber with a diameter 2r₆ for the secondary coating of 148 μm and a 1:1 ratio of the thickness r₆−r₅ of secondary coating to thickness r₅−r₄ of primary coating.

Optical Fibers—Step Index—Triangular Trench. The following six modelled examples Ex1-Ex6 illustrate optical fibers having outer cladding region with a radius r₄=62.5 μm. Each of Ex1-Ex6 had a relative refractive index profile of the type shown in FIG. 6D. Table 1 lists selected parameters for Ex1-Ex6. The shape of the trench cladding region of each of Ex1-Ex6 was triangular with a relative refractive index that varied continuously with a monotonic decrease between the inner radius r₂ and the outer radius r₃ of the trench cladding region. Each of Ex1-Ex6 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 1. The core regions of Ex1-Ex6 included a step-index relative refractive index profile (α=12). V₃ is the trench volume of the trench cladding region. MFD refers to mode field diameter. Δ_{eff} refers to effective area. λ₀ is the zero dispersion wavelength. Each of Ex1-Ex6 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex1-Ex6. The outer radius r₆ of the secondary coating is listed in Table 1.

TABLE 1

| | Ex1 | Ex2 | Ex3 | Ex4 | Ex5 | Ex6 |
|---|---|---|---|---|---|---|
| Δ₁ₘₐₓ (%) | 0.38 | 0.40 | 0.42 | 0.44 | 0.46 | 0.50 |
| r₁ (μm) | 4.05 | 3.95 | 3.8 | 3.7 | 3.63 | 3.45 |
| α | 12 | 12 | 12 | 12 | 12 | 12 |
| Δ₂ (%) | 0 | 0 | 0 | 0 | 0 | 0 |
| r₂ (μm) | 7.0 | 7.0 | 7.0 | 7.0 | 7.0 | 7.0 |
| Δ_{3, min} (%) | −0.50 | −0.50 | −0.50 | −0.50 | −0.50 | −0.50 |
| r₃ (μm) | 14.5 | 14.5 | 14.5 | 14.5 | 14.5 | 14.5 |
| V₃ (% Δ-μm²) | 46 | 46 | 46 | 46 | 46 | 46 |
| Δ₄ (%) | 0 | 0 | 0 | 0 | 0 | 0 |
| r₄ (μm) | 62.5 | 62.5 | 62.5 | 62.5 | 62.5 | 62.5 |
| r₆ (μm) | 87 | 84 | 81 | 78 | 74 | 72 |
| MFD at 1310 nm (μm) | 8.4 | 8.2 | 8 | 7.85 | 7.7 | 7.3 |
| A_{eff} at 1550 nm (μm²) | 68.5 | 65.32 | 62.78 | 60.3 | 57.64 | 53.02 |
| Cable Cutoff (nm) | 1194 | 1191 | 1192 | 1191 | 1190 | 1162 |
| Dispersion at 1310 | −0.353 | −0.749 | −1.106 | −1.501 | −1.891 | −3.171 |
| nm (ps/nm/km) | | | | | | |
| Dispersion Slope at | 0.089 | 0.0885 | 0.0881 | 0.0876 | 0.0871 | 0.0853 |
| 1310 nm (ps/nm²/km) | | | | | | |
| λ₀ (nm) | 1322.0 | 1326.5 | 1330.6 | 1335.1 | 1339.7 | 1355.2 |

Optical Fibers—Step Index—Rectangular Trench. The following twelve modelled examples Ex7-Ex118 illustrate optical fibers having an outer cladding region with a radius r₄=62.5 μm. Each of Ex7-Ex18 had a relative refractive index profile of the type shown in FIG. 6B. Tables 2 and 3 list selected parameters for Ex7-Ex18. The shape of the trench cladding region of each of Ex7-Ex18 was rectangular with a relative refractive index that was constant between the inner radius r₂ and the outer radius r₃ of the trench cladding region. Each of Ex7-Ex118 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Tables 2 and 3. The core regions of Ex7-Ex18 included a step-index relative refractive index profile (α=12). V₃ is the trench volume of the trench cladding region. MFD refers to mode field diameter. Δ_{eff} refers to effective area. λ₀ is the zero dispersion wavelength. Each of Ex7-Ex18 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex7-Ex118. The outer radius r₆ of the secondary coating is listed in Tables 2 and 3.

TABLE 2

| | Ex7 | Ex8 | Ex9 | Ex10 | Ex11 | Ex12 |
|---|---|---|---|---|---|---|
| Δ₁ₘₐₓ (%) | 0.38 | 0.40 | 0.42 | 0.44 | 0.46 | 0.50 |
| r₁ (μm) | 4.05 | 3.95 | 3.8 | 3.7 | 3.63 | 3.45 |
| α | 12 | 12 | 12 | 12 | 12 | 12 |
| Δ₂ (%) | 0 | 0 | 0 | 0 | 0 | 0 |
| r₂ (μm) | 10 | 10 | 10 | 10 | 10 | 10 |
| Δ_{3, min} (%) | −0.32 | −0.32 | −0.32 | −0.32 | −0.32 | −0.32 |
| r₃ (μm) | 16 | 16 | 16 | 16 | 16 | 16 |
| V₃ (% Δ-μm²) | 50 | 50 | 50 | 50 | 50 | 50 |
| Δ₄ (%) | 0 | 0 | 0 | 0 | 0 | 0 |
| r₄ (μm) | 62.5 | 62.5 | 62.5 | 62.5 | 62.5 | 62.5 |
| r₆ (μm) | 87 | 84 | 81 | 78 | 74 | 72 |
| MFD at 1310 nm (μm) | 8.46 | 8.26 | 8.03 | 7.85 | 7.68 | 7.36 |
| A_{eff} at 1550 nm (μm²) | 70.25 | 67.03 | 63.74 | 60.97 | 58.52 | 53.92 |
| Cable Cutoff (nm) | 1213 | 1214 | 1199 | 1194 | 1197 | 1187 |
| Dispersion at 1310 | −0.82 | −1.158 | −1.772 | −2.188 | −2.46 | −3.34 |
| nm (ps/nm/km) | | | | | | |
| Dispersion Slope at | 0.0879 | 0.0873 | 0.0865 | 0.0857 | 0.0851 | 0.0837 |
| 1310 nm (ps/nm²/km) | | | | | | |
| λ₀ (nm) | 1327.3 | 1331.3 | 1338.5 | 1343.5 | 1346.9 | 1357.9 |

TABLE 3

| | Ex13 | Ex14 | Ex15 | Ex16 | Ex17 | Ex18 |
|---|---|---|---|---|---|---|
| Δ₁ₘₐₓ (%) | 0.38 | 0.40 | 0.42 | 0.44 | 0.46 | 0.50 |
| r₁ (μm) | 4.1 | 4.0 | 3.85 | 3.75 | 3.7 | 3.5 |
| α | 12 | 12 | 12 | 12 | 12 | 12 |
| Δ₂ (%) | 0 | 0 | 0 | 0 | 0 | 0 |
| r₂ (μm) | 10 | 10 | 10 | 10 | 10 | 10 |
| Δ_{3, min} (%) | −0.24 | −0.24 | −0.24 | −0.24 | −0.24 | −0.24 |
| r₃ (μm) | 16 | 16 | 16 | 16 | 16 | 16 |
| V₃ (% Δ-μm²) | 37 | 37 | 37 | 37 | 37 | 37 |
| Δ₄ (%) | 0 | 0 | 0 | 0 | 0 | 0 |
| r₄ (μm) | 62.5 | 62.5 | 62.5 | 62.5 | 62.5 | 62.5 |
| r₆ (μm) | 87 | 84 | 81 | 78 | 74 | 72 |
| MFD at 1310 nm (μm) | 8.5 | 8.29 | 8.06 | 7.87 | 7.73 | 7.39 |
| A_{eff} at 1550 nm (μm²) | 70.87 | 67.58 | 64.23 | 61.4 | 59.3 | 54.25 |
| Cable Cutoff (nm) | 1192 | 1194 | 1177 | 1174 | 1184 | 1167 |
| Dispersion at 1310 | −0.72 | −1.026 | −1.06 | −1.987 | −2.41 | −3.05 |
| nm (ps/nm/km) | | | | | | |
| Dispersion Slope at | 0.0875 | 0.0869 | 0.0861 | 0.0854 | 0.0854 | 0.0835 |
| 1310 nm (ps/nm²/km) | | | | | | |
| λ₀ (nm) | 1326.2 | 1329.8 | 1330.3 | 1341.3 | 1346.2 | 1354.5 |

Optical Fibers—Step Index—Triangular Trench—Reduced Clad. The following two modelled examples Ex19-Ex20 illustrate optical fibers having outer cladding region with a radius r₄=55 μm. Each of Ex19-Ex20 had a relative refractive index profile of the type shown in FIG. 6D. Table 4 lists selected parameters for Ex19-Ex20. The shape of the trench cladding region of each of Ex19-Ex20 was triangular with a relative refractive index that varied continuously with a monotonic decrease between the inner radius r₂ and the outer radius r₃ of the trench cladding region. Each of Ex19-Ex20 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 4. The core regions of Ex19-Ex20 included a step-index relative refractive index profile (α=12). V₃ is the trench volume of the trench cladding region. MFD refers to mode field diameter. Δ_{eff} refers to effective area. λ₀ is the zero dispersion wavelength. Each of Ex19-Ex20 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex19-Ex20. The outer radius r₆ of the secondary coating is listed in Table 4.

TABLE 4

| | Ex19 | Ex20 |
|---|---|---|
| Δ₁ₘₐₓ (%) | 0.42 | 0.46 |
| r₁ (μm) | 3.8 | 3.6 |
| α | 12 | 12 |
| Δ₂ (%) | 0 | 0 |
| r₂ (μm) | 7.0 | 7.0 |
| Δ_{3, min} (%) | −0.50 | −0.50 |
| r₃ (μm) | 14.5 | 14.5 |
| V₃ (% Δ-μm²) | 46 | 46 |
| Δ₄ (%) | 0 | 0 |
| r₄ (μm) | 55 | 55 |
| r₆ (μm) | 81 | 74 |
| MFD at 1310 nm (μm) | 8 | 7.7 |
| A_{eff} at 1550 nm (μm²) | 62.78 | 57.64 |
| Cable Cutoff (nm) | 1192 | 1190 |
| Dispersion at 1310 nm | −1.106 | −1.891 |
| (ps/nm/km) | | |
| Dispersion Slope at 1310 | 0.0881 | 0.0871 |
| nm (ps/nm²/km) | | |
| λ₀ (nm) | 1330.5 | 1339.7 |

Optical Fibers—Step Index—Rectangular Trench—Reduced Clad. The following two modelled examples Ex21-Ex22 illustrate optical fibers having outer cladding region with a radius r₄=55 μm. Each of Ex21-Ex22 had a relative refractive index profile of the type shown in FIG. 6B. Table 5 lists selected parameters for Ex21-Ex22. The shape of the trench cladding region of each of Ex21-Ex22 was rectangular with a relative refractive index that was constant between the inner radius r₂ and the outer radius r₃ of the trench cladding region. Each of Ex21-Ex22 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 5. The core regions of Ex21-Ex22 included a step-index relative refractive index profile (α=12). V₃ is the trench volume of the trench cladding region. MFD refers to mode field diameter. Δ_{eff} refers to effective area. λ₀ is the zero dispersion wavelength. Each of Ex21-Ex22 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex21-Ex22. The outer radius r₆ of the secondary coating is listed in Table 5.

TABLE 5

| | Ex21 | Ex22 |
|---|---|---|
| Δ₁ₘₐₓ (%) | 0.42 | 0.46 |
| r₁ (μm) | 3.8 | 3.63 |
| α | 12 | 12 |
| Δ₂ (%) | 0 | 0 |
| r₂ (μm) | 10 | 10 |
| Δ_{3, min} (%) | −0.32 | −0.32 |
| r₃ (μm) | 16 | 16 |
| V₃ (% Δ-μm²) | 50 | 50 |
| Δ₄ (%) | 0 | 0 |
| r₄ (μm) | 55 | 55 |
| r₆ (μm) | 81 | 74 |
| MFD at 1310 nm (μm) | 8.03 | 7.68 |
| A_{eff} at 1550 nm (μm²) | 63.74 | 58.52 |
| Cable Cutoff (nm) | 1199 | 1197 |
| Dispersion at 1310 nm | −1.772 | −2.46 |
| (ps/nm/km) | | |
| Dispersion Slope at 1310 | 0.0865 | 0.0851 |
| nm (ps/nm²/km) | | |
| λ₀ (nm) | 1338.5 | 1346.9 |

Optical Fibers—Graded Index—Triangular Trench. The following two modelled examples Ex23-Ex24 illustrate optical fibers having outer cladding region with a radius r₄=62.5 μm. Each of Ex23-Ex24 had a relative refractive index profile of the type shown in FIG. 5D. Table 6 lists selected parameters for Ex23-Ex24. The shape of the trench cladding region of each of Ex23-Ex24 was triangular with a relative refractive index that varied continuously with a monotonic decrease between the inner radius r₂ and the outer radius r₃ of the trench cladding region. Each of Ex23-Ex24 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 6. The core regions of Ex23-Ex24 included a graded-index relative refractive index profile (α=2). V₃ is the trench volume of the trench cladding region. MFD refers to mode field diameter. Δ_{eff} refers to effective area. λ₀ is the zero dispersion wavelength. Each of Ex23-Ex24 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex23-Ex24. The outer radius r₆ of the secondary coating is listed in Table 6.

TABLE 6

| | Ex23 | Ex24 |
|---|---|---|
| Δ₁ₘₐₓ (%) | 0.50 | 0.55 |
| r₁ (μm) | 4.7 | 4.55 |
| α | 2 | 2 |
| Δ₂ (%) | 0 | 0 |
| r₂ (μm) | 7.0 | 7.0 |
| Δ_{3, min} (%) | −0.50 | −0.50 |
| r₃ (μm) | 14.5 | 14.5 |
| V₃ (% Δ-μm²) | 46 | 46 |
| Δ₄ (%) | 0 | 0 |
| r₄ (μm) | 62.5 | 62.5 |
| r₆ (μm) | 81 | 74 |
| MFD at 1310 nm (μm) | 8.0 | 7.66 |
| A_{eff} at 1550 nm (μm²) | 62.23 | 57.27 |
| Cable Cutoff (nm) | 1189 | 1203 |
| Dispersion at 1310 nm | −2.26 | −2.910 |
| (ps/nm/km) | | |
| Dispersion Slope at 1310 | 0.091 | 0.091 |
| nm (ps/nm²/km) | | |
| λ₀ (nm) | 1342.7 | 1350.1 |

Optical Fibers—Graded Index—Rectangular Trench. The following two modelled examples Ex25-Ex26 illustrate optical fibers having outer cladding region with a radius r₄=62.5 μm. Each of Ex25-Ex26 had a relative refractive index profile of the type shown in FIG. 5B. Table 7 list selected parameters for Ex25-Ex26. The shape of the trench cladding region of each of Ex25-Ex26 was rectangular with a relative refractive index that was constant between the inner radius r₂ and the outer radius r₃ of the trench cladding region. Each of Ex25-Ex26 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 7. The core regions of Ex25-Ex26 included a graded-index relative refractive index profile (α=2). V₃ is the trench volume of the trench cladding region. MFD refers to mode field diameter. A_{eff} refers to effective area. λ₀ is the zero dispersion wavelength. Each of Ex25-Ex26 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex25-Ex26. The outer radius r₆ of the secondary coating is listed in Table 7.

TABLE 7

| | Ex25 | Ex26 |
|---|---|---|
| Δ₁ₘₐₓ (%) | 0.50 | 0.55 |
| r₁ (μm) | 4.7 | 4.55 |
| α | 2 | 2 |
| Δ₂ (%) | 0 | 0 |
| r₂ (μm) | 10 | 10 |
| Δ_{3, min} (%) | −0.32 | −0.32 |
| r₃ (μm) | 16 | 16 |
| V₃ (% Δ-μm²) | 50 | 50 |
| Δ₄ (%) | 0 | 0 |
| r₄ (μm) | 62.5 | 62.5 |
| r₆ (μm) | 81 | 74 |
| MFD at 1310 nm (μm) | 8.02 | 7.68 |
| A_{eff} at 1550 nm (μm²) | 63.32 | 58.13 |
| Cable Cutoff (nm) | 1187 | 1205 |
| Dispersion at 1310 nm | −2.84 | −3.4 |
| (ps/nm/km) | | |
| Dispersion Slope at 1310 | 0.090 | 0.0890 |
| nm (ps/nm²/km) | | |
| λ₀ (nm) | 1349.6 | 1356.2 |

Optical Fibers—Graded Index—Triangular Trench—Reduced Clad. The following two modelled examples Ex27-Ex28 illustrate optical fibers having outer cladding region with a radius r₄=55 μm. Each of Ex27-Ex28 had a relative refractive index profile of the type shown in FIG. 5D. Table 8 lists selected parameters for Ex27-Ex28. The shape of the trench cladding region of each of Ex27-Ex28 was triangular with a relative refractive index that varied continuously with a monotonic decrease between the inner radius r₂ and the outer radius r₃ of the trench cladding region. Each of Ex27-Ex28 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 8. The core regions of Ex27-Ex28 included a graded-index relative refractive index profile (α=2). V₃ is the trench volume of the trench cladding region. MFD refers to mode field diameter. Δ_{eff} refers to effective area. λ₀ is the zero dispersion wavelength. Each of Ex27-Ex28 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex27-Ex28. The outer radius r₆ of the secondary coating is listed in Table 8.

TABLE 8

| | Ex27 | Ex28 |
|---|---|---|
| Δ₁ₘₐₓ (%) | 0.50 | 0.55 |
| r₁ (μm) | 4.7 | 4.55 |
| α | 2 | 2 |
| Δ₂ (%) | 0 | 0 |
| r₂ (μm) | 7.0 | 7.0 |
| Δ_{3, min} (%) | −0.50 | −0.50 |
| r₃ (μm) | 14.5 | 14.5 |
| V₃ (% Δ-μm²) | 46 | 46 |
| Δ₄ (%) | 0 | 0 |
| r₄ (μm) | 55 | 55 |
| r₆ (μm) | 81 | 74 |
| MFD at 1310 nm (μm) | 8.0 | 7.66 |
| A_{eff} at 1550 nm (μm²) | 62.23 | 57.27 |
| Cable Cutoff (nm) | 1189 | 1203 |
| Dispersion at 1310 nm | −2.26 | −2.910 |
| (ps/nm/km) | | |
| Dispersion Slope at 1310 | 0.091 | 0.091 |
| nm (ps/nm²/km) | | |
| λ₀ (nm) | 1342.7 | 1350.1 |

Optical Fibers—Graded Index—Rectangular Trench—Reduced Clad. The following two modelled examples Ex29-Ex30 illustrate optical fibers having outer cladding region with a radius r₄=55 μm. Each of Ex29-Ex30 had a relative refractive index profile of the type shown in FIG. 5B. Table 9 lists selected parameters for Ex29-Ex30. The shape of the trench cladding region of each of Ex29-Ex30 was rectangular with a relative refractive index that was constant between the inner radius r₂ and the outer radius r₃ of the trench cladding region. Each of Ex29-Ex30 included a core region, an offset cladding region surrounding and directly adjacent to the core region, a trench cladding region surrounding and immediately adjacent to the offset cladding region, and an outer cladding region surrounding and directly adjacent to the trench cladding region. The relative refractive index and outer radius of each region is listed in Table 9. The core regions of Ex29-Ex30 included a graded-index relative refractive index profile (α=2). V₃ is the trench volume of the trench cladding region. MFD refers to mode field diameter. A_{eff} refers to effective area. λ₀ is the zero dispersion wavelength. Each of Ex29-Ex30 included a primary coating with an in situ modulus of 0.16 MPa and a secondary coating with an in situ modulus of 1800 MPa. The ratio of the thickness r₆−r₅ of the secondary coating to the thickness r₅−r₄ of the primary coating was 0.8 for each of Ex29-Ex30. The outer radius r₆ of the secondary coating is listed in Table 9.

TABLE 9

| | Ex29 | Ex30 |
|---|---|---|
| Δ₁ₘₐₓ (%) | 0.5 | 0.55 |
| r₁ (μm) | 4.7 | 4.55 |
| α | 2 | 2 |
| Δ₂ (%) | 0 | 0 |
| r₂ (μm) | 10 | 10 |
| Δ_{3, min} (%) | −0.32 | −0.32 |
| r₃ (μm) | 16 | 16 |
| V₃ (% Δ-μm²) | 50 | 50 |
| Δ₄ (%) | 0 | 0 |
| r₄ (μm) | 55 | 55 |
| r₆ (μm) | 81 | 74 |
| MFD at 1310 nm (μm) | 8.02 | 7.68 |
| A_{eff} at 1550 nm (μm²) | 63.32 | 58.13 |
| Cable Cutoff (nm) | 1187 | 1205 |
| Dispersion at 1310 nm | −2.84 | −3.4 |
| (ps/nm/km) | | |
| Dispersion Slope at 1310 | 0.0900 | 0.0890 |
| nm (ps/nm²/km) | | |
| λ₀ (nm) | 1349.6 | 1356.2 |

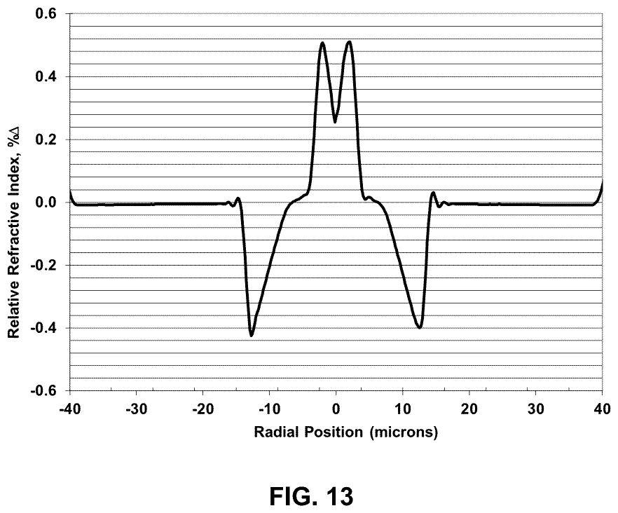

Optical Fiber-Manufactured Fiber. Optical Fibers with MFD at 1310 nm between 7.6 microns and 7.9 microns were made with glass cladding diameter 2r₄ of 80.0 microns, 100.0 microns and 125.0 microns. The relative refractive index profile for the manufactured optical fiber with a cladding diameter 2r₄ of 80.0 microns is shown in FIG. 13. The relative refractive index profiles for 100.0 micron and 125.0 micron manufactured fibers were similar except for the difference in the thickness of the outer cladding layer. The glass diameters, modulus of primary coating, diameter of primary coating, modulus of secondary coating, diameter of secondary coating, and optical properties of the manufactured optical fibers are shown in Table 10. Puncture resistance is measured in units of gf (grams force).

TABLE 10

| | Ex31 | Ex32 | Ex33 |
|---|---|---|---|
| Glass Diameter, 2r₄ (μm) | 125.0 | 100.7 | 80.7 |
| Primary Coating Modulus (MPa) | 0.30 | 0.30 | 0.30 |
| Secondary Coating Modulus (MPa) | 2560 | 1800 | 1800 |
| Primary Coating | 137.0 | 126.1 | 122.1 |
| Diameter, 2r₅ (μm) | | | |
| Secondary Coating | 153.0 | 155.4 | 152.5 |
| Diameter, 2r₆ (μm) | | | |
| Attenuation at 1550 nm (dB/km) | 0.212 | 0.233 | 0.221 |
| Mode Field Diameter | 7.60 | 7.77 | 7.86 |
| at 1310 nm (μm) | | | |
| Mode Field Diameter | 9.06 | 8.82 | 8.97 |
| at 1550 nm (μm) | | | |
| Cable Cutoff (nm) | 1220 | 1220 | 1160 |
| Puncture Resistance (g_{f}) | 17.0 | 18.4 | 23.1 |

Based on the above examples, the following parameters are preferred:

The mode field diameter at 1310 nm of optical fibers disclosed herein is in the range from 7.3 μm to 8.2 μm, or in the range from 7.4 μm to 8.1 μm, or in the range from 7.5 μm to 8.0 μm.

The effective area Δ_{eff} at 1550 nm of optical fibers disclosed herein is in the range from 40 μm² to 85 μm², or in the range from 45 μm² to 80 μm², or in the range from 50 μm² to 75 μm², or in the range from 52.5 μm² to 72.5 μm², or in the range from 55 μm² to 70 μm².

The zero dispersion wavelength λ₀ of optical fibers disclosed herein is in the range from 1280 nm to 1370 nm, or in the range from 1290 nm to 1360 nm, or in the range from 1300 nm to 1350 nm, or in the range from 1310 nm to 1345 nm.

The dispersion at 1310 nm of optical fibers disclosed herein is in the range from −3.5 ps/nm/km to 0.0 ps/nm/km, or in the range from −3.3 ps/nm/km to −0.3 ps/nm/km, or in the range from −3.0 ps/nm/km to −0.5 ps/nm/km, or in the range from −2.7 ps/nm/km to −0.7 ps/nm/km, or in the range from −2.5 ps/nm/km to −1.0 ps/nm/km, or in the range from −2.3 ps/nm/km to −1.2 ps/nm/km, or in the range from −2.0 ps/nm/km to −1.5 ps/nm/km.

The dispersion slope at 1310 nm of optical fibers disclosed herein is in the range from in the range from 0.075 ps/nm²/km to 0.099 ps/nm²/km, or in the range from 0.077 ps/nm²/km to 0.097 ps/nm²/km, or in the range from 0.080 ps/nm²/km to 0.095 ps/nm²/km, or in the range from 0.082 ps/nm²/km to 0.092 ps/nm²/km.

The cable cutoff wavelength of the optical fibers disclosed herein is less than or equal to 1260 nm, or less than or equal to 1240 nm, or less than or equal to 1220 nm, or less than or equal to 1200 nm, or less than or equal to 1180 nm, or less than or equal to 1160 nm, or less than or equal to 1140 nm, or less than or equal to 1120 nm, or in the range from 1100 nm to 1260 nm, or in the range from 1120 nm to 1250 nm, or in the range from 1140 nm to 1240 nm, or in the range from 1160 nm to 1230 nm, or in the range from 1180 nm to 1220 nm, or greater than or equal to 1125 nm and less than or equal to 1260 nm.

Macrobend loss is calculated at 1550 nm for mandrel diameters of 15 mm, 20 mm, and 30 mm. The conditions used in the computation of macrobend loss were in accordance with the mandrel wrap test specified in standard TIA-455-62: FOTP-62 IEC-60793-1-47 Optical Fibres—Part 1-47: Measurement Methods and Test Procedures—Macrobending Loss, by Telecommunications Industry Association (TIA). In the mandrel wrap test, the fiber is wrapped one or more times around a smooth cylindrical mandrel having a specified diameter, and the increase in attenuation at a specified wavelength due to the bending is determined. Macrobend loss is expressed in units of dB/turn, where dB refers to decibels and one turn refers to one revolution of the fiber about the mandrel.

The macrobend loss at 1550 nm of optical fibers disclosed herein, in accordance with the mandrel wrap test using a mandrel with a diameter of 30 mm, is less than or equal to 0.0040 dB/turn, or less than or equal to 0.0035 dB/turn, or less than or equal to 0.0030 dB/turn, or less than or equal to 0.0025 dB/turn, or less than or equal to 0.0020 dB/turn, or in the range from 0.0015 dB/turn to 0.0040 dB/turn, or in the range from 0.0020 dB/turn to 0.0035 dB/turn.

The macrobend loss at 1550 nm of optical fibers disclosed herein, in accordance with the mandrel wrap test using a mandrel with a diameter of 20 mm, is less than or equal to 0.20 dB/turn, or less than or equal to 0.15 dB/turn, or less than or equal to 0.12 dB/turn, or less than or equal to 0.10 dB/turn, or less than or equal to 0.08 dB/turn, or less than or equal to 0.05 dB/turn, or in the range from 0.05 dB/turn to 0.20 dB/turn, or in the range from 0.05 dB/turn to 0.15 dB/turn, or in the range from 0.07 dB/turn to 0.13 dB/turn.

The macrobend loss at 1550 nm of optical fibers disclosed herein, in accordance with the mandrel wrap test using a mandrel with a diameter of 15 mm, is less than or equal to 0.70 dB/turn, or less than or equal to 0.60 dB/turn, or less than or equal to 0.50 dB/turn, or less than or equal to 0.40 dB/turn, or less than or equal to 0.30 dB/turn, or in the range from 0.20 dB/turn to 0.70 dB/turn, or in the range from 0.30 dB/turn to 0.60 dB/turn, or in the range from 0.35 dB/turn to 0.55 dB/turn.

The optical fibers disclosed herein are suited to use in cables intended for high-density applications. Optical fiber cables are often installed in ducts to facilitate installation of the cables by pulling or jetting. Cost-effective installation of optical fiber cables is often limited by the ability of a cable to be effectively pulled or jetted through such ducts. Since duct space is limited, and the installation of ducts themselves is costly, various attempts have been made to increase a number of optical fibers in a cable for a given outside diameter of the cable. However, microbending losses exhibited by the optical fibers have led to limited success by the industry in achieving higher fiber density without unacceptably increasing attenuation.

By contrast, the optical fiber cables described below, incorporating the novel optical fibers described herein, are capable of simultaneously achieving high fiber density and low attenuation.

As used herein, “fiber density” of an optical fiber cable refers to a number of distinct optical fibers divided by the area of a circle that has a diameter equal to an outside diameter of the optical fiber cable.

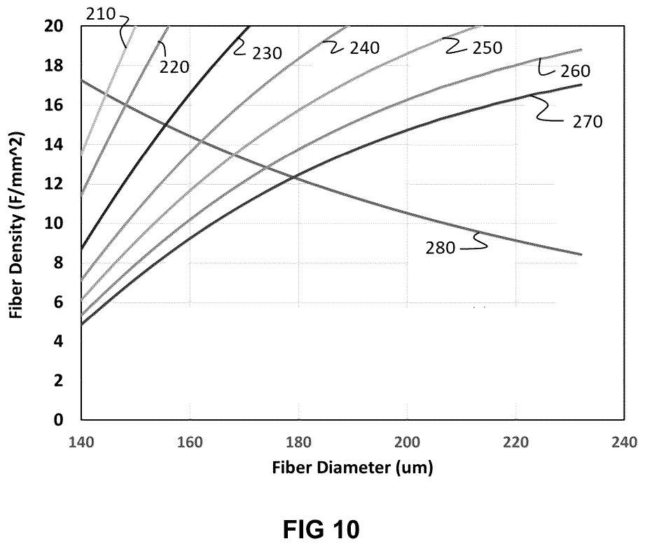

Modeling efforts by the inventors have indicated that practical achievable fiber density in an optical fiber cable depends on fiber diameter, cable core packing density, fiber primary coating modulus, fiber secondary coating modulus, fiber mode field diameter and trench volume of the fiber refractive index profile. Referring now to FIG. 10, a diagram of maximum fiber density for a loose fiber cable plotted against outside fiber diameter is shown for a modeled cable having single-core fibers disposed in subunits surrounded by a cable jacket. For the purposes of the model described by FIG. 10, each optical fiber is assumed to have a same outer diameter, which is a diameter of the fiber taken at its outermost coating layer. Trace 280 depicts a maximum number of optical fibers that can be packed into available space within the modeled cable, assuming that the modeled cable has a minimum cable jacket wall thickness of 1.3 mm, a maximum fiber filling coefficient in each subunit of 77%, and a maximum subunit packing density in a central bore defined by the cable jacket of 80% wherein the subunit packing density refers to a fraction of the cross-sectional area of the central bore of the cable (i.e., the area enclosed by the inner surface of the cable jacket) that is occupied by the subunits. For the purposes of computing subunit packing density of a cable, it is assumed that any free space within the subunits themselves is nevertheless occupied by the subunits.

As can be seen from FIG. 10, a maximum number of optical fibers that can be packed into a cable generally decreases with increasing fiber diameter. However, this maximum packing density is often not achievable in practical optical fiber cables due to other cable requirements and constraints, particularly limits on maximum allowable attenuation and attenuation increase during thermal cycling. As a number of optical fibers in a cable is increased, all else being equal, microbending-induced attenuation tends to increase. Thus, FIG. 10 shows plots of expected maximum achievable fiber density in the modeled cable when constrained by microbending-induced attenuation for optical fibers having different MFDs, a same in-situ primary coating modulus of 0.16 MPa, and a same secondary coating modulus of 1800 MPa. The MFDs depicted in FIG. 10 are 7.3 μm (Trace 210), 7.7 μm (Trace 220), 7.85 μm (Trace 230), 8.0 μm (Trace 240), 8.2 μm (Trace 250), 8.4 μm (Trace 260), and 8.6 μm (Trace 270) at a wavelength of 1310 nm.

In particular, Traces 210-270 of FIG. 10 show, for each of the modeled optical fibers, a maximum density achievable in the modeled cable while maintaining an attenuation change of less than or equal to 0.15 dB/km at a lowest temperature during a thermal cycling test (e.g., −40° C. during a thermal cycling test performed according to IEC 60794-1-212:2024). As can be seen from FIG. 10, for each of the optical fibers there is a generally positive relationship between fiber diameter and cable fiber density, ultimately limited by the “Max Density” curve (Trace 280) illustrating the packing limit of fibers in the modeled cable. Generally, the lower the MFD of the optical fibers, the greater the optical fiber density at which the microbending-constrained curves intersect with the geometric packing limit of the modeled cable. Further, the intersection points of these curves shown in FIG. 10 provide an expected optimum fiber outside diameter balancing microbend sensitivity and geometric packing limit to yield a highest packing density for each fiber design. For instance, an expected optimum fiber outside diameter for the 8.6-μm-MFD fiber modeled is slightly less than 180 μm, yielding a fiber density of slightly more than 12 fibers/mm² in the modeled cable. An expected optimum fiber outside diameter for a fiber having 8.4-μm-MFD fiber is 174 μm yielding a fiber density of 12.2 fibers/mm². An expected optimum fiber outside diameter for the 8.2-μm-MFD fiber is 168 μm yielding a fiber density of 13.4 fibers/mm². An expected optimum fiber outside diameter of the 8-μm-MFD fiber is 162 μm, yielding a fiber density of 14.1 fibers/mm². An expected optimum fiber outside diameter for the 7.85-μm-MFD fiber is 156 μm, yielding a fiber density of 15.2 fibers/mm². The optical fiber 13 at MFD of 7.7 μm is expected to allow the modeled cable to achieve a fiber density of approximately 16 fibers/mm² if the optical fiber 13 has an outside diameter of 148 μm. The optical fiber 13 at MFD of 7.3 μm is expected to allow the modeled cable to achieve a fiber density of approximately 16.2 fibers/mm² if the optical fiber 13 has an outside diameter of 144 μm. Optical fibers considered in the modeling for FIG. 10 each had a trench-assisted design with a refractive index trench having a trench volume of approximately 46% A μm². It is to be appreciated that the microbend-constrained curves for particular fiber designs shown in FIG. 10 may not be valid for other fiber designs. For instance, changes in coatings or trench volume may yield different achievable optimal combinations of fiber density in a cable or optical fiber diameter.

It is to be appreciated that the expected optimum combinations of fiber diameter and fiber density illustrated in FIG. 10 are only achievable with a cable design that is capable of achieving the subunit packing density and cable core packing density of the modeled cable, as represented by the “Max Density” curve (Trace 280) of FIG. 10. A cable joining low MFD fibers, such as the optical fibers 13 described herein, with a high-density cable design capable of achieving dense packing can achieve fiber densities that have heretofore been out of practical reach for single-core-fiber cables.

The microbending of optical fibers in intermittently-bonded ribbons are systematically higher than the microbending of fibers in loose fiber cable and hence intermittently-bonded ribbon cables have lower fiber densities than loose fiber cable. Furthermore, as discussed above, the microbend sensitivity of the optical fibers described herein decreases with each of 1) increasing trench volume, 2) decreasing primary coating modulus, and 3) increasing secondary coating modulus. Tables 11a-11g illustrate maximum fiber densities (and optimum outermost coating diameters for achieving such densities) for cables having various combinations of fiber trench volume, primary coating modulus, secondary coating modulus, and loose or ribbon cable construction. In Table 11a are shown the maximum fiber densities for loose fiber cables as a function of fiber MFD for trench assisted optical fibers having trench volume of 45% Δ-μm², primary coating in situ modulus of 0.16 MPa and secondary coating modulus of 1800 MPa.

TABLE 11a
Loose Fiber Cables

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 45 | 0.16 | 1800 | 180 | 12.44 |
| 8.4 | 45 | 0.16 | 1800 | 174 | 12.79 |
| 8.2 | 45 | 0.16 | 1800 | 168 | 13.49 |
| 8 | 45 | 0.16 | 1800 | 162 | 14.13 |
| 7.85 | 45 | 0.16 | 1800 | 156 | 15.16 |
| 7.7 | 45 | 0.16 | 1800 | 148 | 15.88 |

In Table 11b are shown the maximum fiber densities for intermittently-bonded ribbon cables as a function of fiber MFD for trench assisted optical fibers having trench volume of 45% Δ-μm², primary coating in situ modulus of 0.16 MPa and secondary coating modulus of 1800 MPa.

TABLE 11b
Ribbon Cables

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 45 | 0.16 | 1800 | 196 | 10.73 |
| 8.4 | 45 | 0.16 | 1800 | 190 | 11.32 |
| 8.2 | 45 | 0.16 | 1800 | 182 | 12.03 |
| 8 | 45 | 0.16 | 1800 | 174 | 12.78 |
| 7.85 | 45 | 0.16 | 1800 | 166 | 13.87 |
| 7.7 | 45 | 0.16 | 1800 | 156 | 14.92 |

In Table 11c are shown the maximum fiber densities for intermittently-bonded ribbon cables as a function of fiber MFD for trench assisted optical fibers having trench volume of 45% Δ-μm², primary coating in situ modulus of 0.16 MPa and secondary coating modulus of 2500 MPa.

TABLE 11c
Ribbon Cables with High Modulus Secondary Coating

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 45 | 0.16 | 2500 | 190 | 11.32 |
| 8.4 | 45 | 0.16 | 2500 | 184 | 11.84 |
| 8.2 | 45 | 0.16 | 2500 | 176 | 12.42 |
| 8 | 45 | 0.16 | 2500 | 170 | 13.36 |
| 7.85 | 45 | 0.16 | 2500 | 162 | 14.26 |
| 7.7 | 45 | 0.16 | 2500 | 154 | 15.68 |

In Table 11d are shown the maximum fiber densities for loose-fiber cables as a function of fiber MFD for trench assisted optical fibers having trench volume of 45% Δ-μm², primary coating in situ modulus of 0.23 MPa and secondary coating modulus of 1800 MPa.

TABLE 11d
Loose Fiber Cables with Intermediate Primary Coating Modulus

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 45 | 0.23 | 1800 | 192 | 11.06 |
| 8.4 | 45 | 0.23 | 1800 | 186 | 11.6 |
| 8.2 | 45 | 0.23 | 1800 | 178 | 12.23 |
| 8 | 45 | 0.23 | 1800 | 172 | 12.85 |
| 7.85 | 45 | 0.23 | 1800 | 164 | 14.22 |
| 7.7 | 45 | 0.23 | 1800 | 154 | 15.08 |

In Table 11e are shown the maximum fiber densities for intermittently-bonded ribbon cables as a function of fiber MFD for trench assisted optical fibers having trench volume of 45% Δ-μm², primary coating in situ modulus of 0.23 MPa and secondary coating modulus of 1800 MPa.

TABLE 11e
Ribbon Cables with Intermediate Primary Coating Modulus

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 45 | 0.23 | 1800 | 214 | 9.45 |
| 8.4 | 45 | 0.23 | 1800 | 206 | 10.04 |
| 8.2 | 45 | 0.23 | 1800 | 196 | 10.78 |
| 8 | 45 | 0.23 | 1800 | 186 | 11.59 |
| 7.85 | 45 | 0.23 | 1800 | 176 | 12.72 |
| 7.7 | 45 | 0.23 | 1800 | 164 | 14 |

In Table 1 if are shown the maximum fiber densities for loose-fiber cables as a function of fiber MFD for trench assisted optical fibers having trench volume of 37% Δ-μm², primary coating in situ modulus of 0.16 MPa and secondary coating modulus of 1800 MPa.

TABLE 11f
Loose Fiber Cables with Intermediate Trench Volume

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 37 | 0.16 | 1800 | 184 | 12.01 |
| 8.4 | 37 | 0.16 | 1800 | 178 | 12.45 |
| 8.2 | 37 | 0.16 | 1800 | 172 | 13.21 |
| 8 | 37 | 0.16 | 1800 | 164 | 13.58 |
| 7.85 | 37 | 0.16 | 1800 | 158 | 14.7 |
| 7.7 | 37 | 0.16 | 1800 | 150 | 15.69 |

In Table 11g are shown the maximum fiber densities for intermittently-bonded ribbon cables as a function of fiber MFD for trench assisted optical fibers having trench volume of 37% Δ-μm², primary coating in situ modulus of 0.16 MPa and secondary coating modulus of 1800 MPa.

TABLE 11g
Ribbon Cables with Intermediate Trench Volume

| | | | | | Maximum |
|---|---|---|---|---|---|
| | | Primary | Secondary | Outermost | Fiber |
| MFD at | Trench | Coating | Coating | Coating | Density in |
| 1310 nm | Volume | Modulus | Modulus | Diameter | Cables |
| (μm) | (% Δ-μm²) | (MPa) | (MPa) | (μm) | (#/mm²) |
| 8.6 | 37 | 0.16 | 1800 | 202 | 10.34 |
| 8.4 | 37 | 0.16 | 1800 | 196 | 10.98 |
| 8.2 | 37 | 0.16 | 1800 | 186 | 11.59 |
| 8 | 37 | 0.16 | 1800 | 178 | 12.44 |
| 7.85 | 37 | 0.16 | 1800 | 168 | 13.27 |
| 7.7 | 37 | 0.16 | 1800 | 158 | 14.48 |

As will be understood from the foregoing, various combinations of fiber MFD, primary coating modulus, secondary coating modulus, outermost coating diameter and loose-fiber vs. ribbon cable construction yield different maximum fiber densities, and the embodiments described herein are not limited to those discussed specifically above with respect to tables 11a-11g.

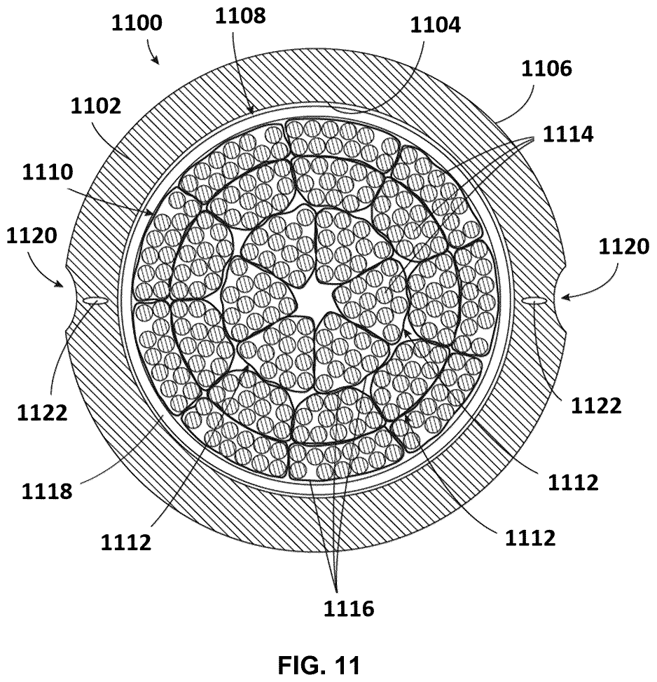

Referring now to FIG. 11, a high fiber density optical fiber cable 1100 is illustrated. The optical fiber cable 1100 has a design configured to allow high fiber packing density within each of several subunits, and a high subunit packing density within a core of the cable 1100. Thus, when employed with the inventive optical fibers 13 described herein, the high-density optical fiber cable 1100 is well-suited to achieving loose fiber densities in excess of 12 fibers/mm² and ribbon-fiber densities in excess of 11 fibers/mm². It is to be appreciated that Table 11a, Table 11b, and Table 11c expressly enumerate only certain exemplary embodiments for a high density optical fiber cable, but that the scope of the present disclosure is not limited solely to these embodiments. In particular, the present application contemplates inventive embodiments with parameters in the ranges between those set points described in Tables 11a-11c. For example, Table 11a describes loose-fiber high density cables having optical fibers with MFD at 1310 nm of 8.4 μm, fiber secondary coating diameter of 174 μm and a cable fiber density of 12.79 fibers/mm², as well as loose-fiber high density cables having optical fibers with MFD at 1310 nm of 8.2 μm, a fiber secondary coating diameter of 168 μm and a fiber density of 13.49 fibers/mm². Accordingly, Table 11a is to be interpreted to disclose cables having fibers with MFD at 1310 nm of between 8.2 μm and 8.4 μm, fiber secondary coating diameter of between 168 μm and 174 μm, and cable fiber density of at least 12.79 fibers/mm².

The optical fiber cable 1100 includes a cable jacket 1102 having an inner surface 1104 and an outer surface 1106. The inner surface 1104 of the optical fiber cable 1100 defines a central bore 1108 that extends along a longitudinal axis of the optical fiber cable 1100. The outer surface 1106 defines an outermost surface of the optical fiber cable 1100. Generally, the cable jacket 1102 is formed from one or more extrudable polymeric materials. The cable jacket 1102 can have one or more layers. Furthermore, the cable jacket 1102 can have reinforcing fibers or filaments embedded therein.

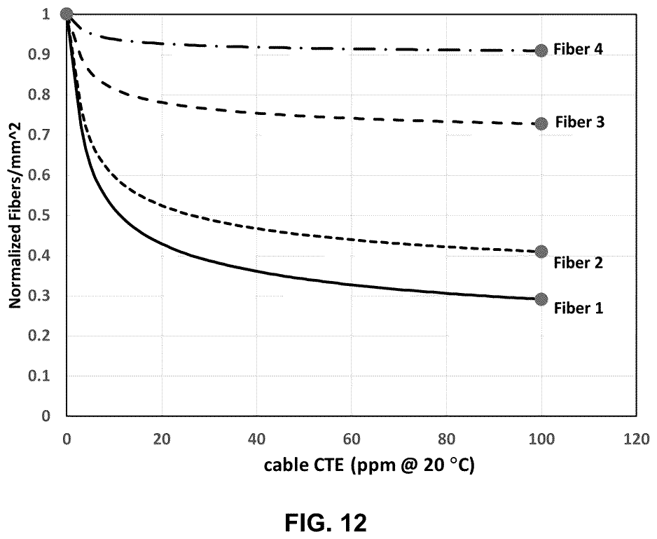

Referring now to FIG. 12, a diagram is shown that illustrates a modeled relationship between coefficient of linear thermal expansion (CTE) at 20° C. of the cable jacket 1102 and a fiber density of an optical fiber cable for four different optical fibers having different combinations of glass profile (i.e., configuration of glass core and cladding) and coating systems (e.g., primary and/or secondary coating modulus). The diagram of FIG. 12 shows that the fiber density, normalized to a fiber density achievable at a cable jacket CTE of 0 ppm/° C., generally decreases as cable jacket CTE increases for each of the 4 modeled fibers. However, the greatest impacts on fiber density for each of the fibers are observed as the CTE increases from 0 ppm/° C. to 100 ppm/° C., after which the reduction in fiber density for increases in CTE levels off. Accordingly, in embodiments, the cable jacket 1102 is configured to have a CTE of less than or equal to 100 ppm/° C. at 20° C., or still more particularly less than or equal to 50 ppm/° C. at 20° C., or yet more particularly less than or equal to 20 ppm/° C. at 20° C. By way of example, and not limitation, the cable jacket 1102 can be formed from polyethylene or other polymer or polymer blend that is reinforced by extruded filaments of polycarbonate or a liquid crystal polymer (LCP). In still other examples, the cable jacket 1102 can be formed from a copolyester and stabilizer blend that on its own exhibits such a low CTE.

Referring once again to FIG. 11, disposed within the central bore 1108 of the optical fiber cable 1100 is cable core 1110 including a plurality of subunits 1112. The subunits 1112 each include a plurality of optical fibers 1114 surrounded by a membrane 1116. The optical fibers 1114 can be, for example, the optical fibers 13 described in detail above.

The membrane 1116 is formed from an extruded polymeric material. The thermoplastic polymers are not particularly limited in terms of molecular weight and distributions, and the thermoplastic polymers may be homopolymers, heteropolymers, or copolymers. In general, the thermoplastic polymers are selected from among polyolefins, polyvinylchloride, polystyrene, acrylonitrile butadiene styrene, styrene-acrylonitrile, styrene-ethylene-butylene-styrene, and technical thermoplastics. In one or more embodiments, the polyolefins include polyethylenes (very low density, linear low density, low density, medium density, high density, and ultrahigh molecular weight), polypropylene (isotactic, syndiotactic, and atactic), and polyolefin-based thermoplastic elastomers (such as ethylene vinyl acetate, ethylene butyl acrylate, ethylene methyl acrylate, thermoplastic olefin elastomer, ethylene-propylene rubber, and ethylene propylene diene monomer rubber). In one or more embodiments, the technical thermoplastics include polyesters (such as polybutylene terephthalate, polyethylene terephthalate, polycarbonate, poly methyl methacrylate, and polyoxymethylene), polyethers (such as polyphenylene ether and poly(p-phenylene oxide)), polyamides (such as polyamide 6, polyamide 12, polyamide 6.6, polyamide 4.6, and polyamide 11), polyacetal, polysulfones (such as polyethersulfone, polysulfone, and polyphenylene sulfide), polyimides, and polyketones.

The membrane 1116 is a thin and flexible sheath that allows for the subunit 1112 to be reconfigured into a variety of different shapes. In this way, the subunits 1112 can be densely packed within the cable core 1110 by changing shape, e.g., flattening out, bunching up, or bending, as necessary to fill space within the cable core 110.

In one or more embodiments, the interior surface of the membrane 1116 defines an interior cross-sectional area of the subunit 1112. The portion of this interior cross-sectional area that is not occupied by the optical fibers 1114 is referred to as “free space.” In one or more embodiments, each subunit 1112 comprises a free space of 50% or less, 40% or less, 30% or less, or 25% or less. The low free space within the subunits 1112 contributes to the high fiber density of the optical fiber cable 1100. In one or more embodiments, the subunits 1112 may also include a water-blocking material, such as a water-blocking gel, super-absorbent powders, or water-blocking yarn.

The subunits 1112 may be stranded (such as SZ-stranded) in the cable core 1110 in embodiments. The stranding enhances the ability to bend the cable while minimizing tensile and contractive forces within any of the fibers. During cable bending, the optical fibers 1114 must be able to shift position, moving longitudinally to relieve those forces so as not to cause attenuation or break the optical fibers 1114. Because the membranes 1116 and cable core 1110 provide limited free space for the optical fibers 1114 to increase fiber density by design, the subunits 1112 may be configured to move relative to each other in certain embodiments by using solid or gel lubricants, such as talc, or using water-absorbing powders.

Thus, in one or more embodiments, the optical fiber cable 1100 may consist essentially of the cable jacket 1102 surrounding a plurality of subunits 1112. Other components that do not affect the basic and novel characteristics of the optical fiber cable 1100 that may be included are, for example, a binder 1118 provided between the plurality of subunits 1112 and the cable jacket 1102 (e.g., to maintain a stranding of the subunits 1112, or to provide organization to subgroups of the subunits 1112), water blocking material (e.g., tapes and powders), lubricants, friction-enhancing materials, and access features (e.g., ripcords or preferential tear features, such as a strip of dissimilar polymer in the cable jacket 1102). In one or more embodiments, armor layers and strength elements are excluded from the construction of the optical fiber cable 1100. However, it is to be appreciated that in other embodiments, an armor layer can be included between binder 1118 and the cable jacket 1102 or strength elements such as fiber-reinforced plastic rods (FRPs) or steel wires can be embedded in the cable jacket 1102. In embodiments wherein strength elements are embedded in the jacket, a number of the strength elements can be greater than or equal to 2, greater than or equal to 4, or greater than or equal to 8.

In one or more embodiments, the thickness of the membrane 1116 is 100 μm or less, 90 μm or less, 80 μm or less, 70 μm or less, 60 μm or less, 50 μm or less, or 40 μm or less. In one or more embodiments, the thickness of the membrane 1116 is 10 μm or more, 20 μm or more, 30 μm or more, or 35 μm or more. In one or more embodiments, the thickness of the membrane 1116 is from 10 μm to 100 μm, in particular from 25 μm to 75 μm, and most particularly from 35 μm to 50 μm.

In one or more embodiments, the membrane 1116 groups from two to one hundred forty-four optical fibers 1114 into a subunit 1112. In various embodiments, the optical fibers 1114 in a subunit 1112 can be further organized as optical fiber ribbons, in particular intermittently-bonded or “rollable” optical fiber ribbons. It will be appreciated that the optical fiber cable 1100 described herein can have substantially any number of optical fibers 1114, depending on an inside diameter of the cable 1100.

In one or more embodiments, the subunits 1112 are surrounded by a binder 1118. In one or more embodiments, the binder 1118 is a thin film jacket having a thickness between 40 μm and 150 μm. In one or more embodiments, the binder 1118 is provided to prevent sticking between the subunits 1112 and the cable jacket 1102, and thus, in one or more embodiments, the material of the binder 1118 is selected to prevent sticking to both the subunits 1112 and the cable jacket 1102. Advantageously, using a thin binder 1118 having a thickness in the disclosed thickness range reduces the thermal load of the binder 1118 on the subunits 1112 during extrusion of the binder 1118.

In one or more embodiments, the cable jacket 1102 has a thickness between the inner surface 1104 and the outer surface 1106 in a range from 0.5 mm to 1.5 mm. In one or more embodiments, the cable jacket 1102 is made from a polyethylene material (such as high density polyethylene (HDPE)), a low-smoke zero halogen (LSZH) polymer, a filled polyethylene, a flame retardant (FR) polymer, or a urethane polymer, amongst other possibilities.

In one or more embodiments, the cable jacket 1102 includes tactile locator features 1120. In the embodiment depicted, the tactile locator features 1120 comprise diametrically arranged depressions defined by the outer surface 1106 of the cable jacket 1102. However, in one or more other embodiments, the tactile locator features 1120 comprise diametrically arranged bumps defined by the outer surface 1106 of the cable jacket 1102. The tactile locator features 1120 assist a user in opening the cable 1100 by guiding the user to the location of access features 1122. In the embodiment of the optical fiber cable 1100, the access features 1122 are strips of dissimilar polymer embedded in the polymer of the cable jacket 1102. For example, the cable jacket 1102 may substantially comprise polyethylene, and the dissimilar polymer of the access feature 1122 may be polypropylene. The immiscibility of polyethylene cable jacket 1102 and the polypropylene access features 1122 prevents a strong bond from forming between the cable jacket 1102 and the access features 1122, allowing for a user to tear through the cable jacket 1102 in the region of the access features 1122. Further, once opened at the access features 1122, the cable jacket 1102 can be split along its length along the access features 1122. It is to be appreciated that in some embodiments the access features 1122 and/or tactile locator features 1120 may be omitted, and the cable 1100 can instead include one or more ripcords, either embedded in the cable jacket 1102 or disposed in the central bore 1108.

In one or more embodiments, the optical fiber cable 1100 has a cumulative fiber filling coefficient of at least 50%, at least 60%, at least 65%, or at least 70%. In one or more embodiments, the optical fiber cable 1100 has a cumulative fiber filling coefficient of up to 85%. As used herein, the term “cumulative fiber filling coefficient” of an optical-fiber cable 1100 refers to the ratio of the sum of the cross-sectional areas of all of the optical fibers 1114 within the optical-fiber cable 1100 versus the inner cross-sectional area of the optical-fiber cable 1100 (i.e., defined by the inner surface 1104 of the cable jacket 1102 or inner surface of binder 1118, if included). The cross-sectional area of each optical fiber 1114 is determined based on an outer surface of the optical fiber 1114.

In one or more embodiments, the optical fiber cable 1100 comprises a free space of at most 50%, at most 42.5%, at most 30%, or at most 25%. In one or more embodiments, the free space of the optical fiber cable 1100 is at least 15%. As used herein, the free space is the inverse of cumulative fiber filling coefficient (i.e., 100%—cumulative fiber filling coefficient).

The optical fiber cable 1100 described above, when employing the optical fibers 13 described herein, can be configured to have a higher fiber density than prior art optical fiber cables using single-core fibers. In exemplary embodiments, the optical fiber cable 1100 can be constructed to have a fiber density of greater than or equal to 12 fibers/mm², or more particularly greater than or equal to 13 fibers/mm², even more particularly greater than or equal to 14 fibers/mm², still more particularly greater than or equal to 15 fibers/mm², or yet more particularly greater than or equal to 16 fibers/mm². In exemplary embodiments, a total number of optical fibers 1114 in the optical fiber cable 1100 can be between 8 and 13824, between 8 and 6912, between 8 and 3456, between 8 and 1728, between 144 and 13824, between 144 and 6912, between 144 and 3456, between 144 and 1728, between 144 and 864, between 288 and 13824, between 288 and 6912, between 288 and 3456, between 288 and 1728, between 288 and 864, between 432 and 13824, between 432 and 6912, between 432 and 3456, between 432 and 1728, or between 432 and 864, all ranges inclusive.

Still further, optical fiber cables described above can be configured to have such fiber densities while continuing to meet stringent standards for optical signal attenuation. In various embodiments, the optical fiber cable 1100 exhibits an attenuation increase for a transmitted wavelength of 1550 nm of less than 0.15 dB/km when cooled for a second time to a temperature of −20° C. during a temperature cycling test performed according to IEC 60794-1-212:2024. In still further embodiments, the optical fiber cable 1100 exhibits an attenuation increase at 1550 nm of less than 0.15 dB/km when cooled for a second time to a temperature of −30° C., or for a second time to a temperature of −40° C. during such temperature cycling test performed according to IEC 60794-1-212:2024.

The inventors have further observed that optical fiber cables with a high ratio of polymeric elements to strength elements tend to exhibit greater attenuation changes during thermal cycling. Accordingly, the optical fiber cable 1100 can be constructed to have a relatively low fraction of plastic elements relative to strength elements, as measured by cross-sectional area. In embodiments, looking at an end of the cable 1100, the cable 1100 can have a ratio of cross-sectional area of plastic elements to cross-sectional area of strength elements of between 4 and 8, or more particularly between 4 and 6. For the purposes of evaluating a plastic-to-strength ratio of the cable 1100, elements such as the cable jacket 1102 (exclusive of any reinforcement disposed therein) and membranes 1116 are considered “plastic,” whereas FRPs, metal strength elements, tensile yarns (e.g., aramid yarns or fibers), and the optical fibers 1114 themselves are considered “strength,” whether or not they include polymeric elements (e.g., FRPs).

While various embodiments of a high density optical fiber cable having low-MFD optical fibers have been described herein, it is to be appreciated that the optical fibers 13 described herein can be employed in any of various cable designs. By way of example, it may be advantageous to form connections between a high density cable 1100 and other components of an optical system (e.g., in a data center) by way of a jumper cable with fibers that have a matching MFD to the fibers 1114 in the high-density cable 1100. Accordingly, the optical fibers 13 described herein are suitable for use with other cables, such as but not limited to jumper cables, that are not configured as high-density cables.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An optical fiber cable, comprising:
a cable jacket having an inner surface and an outer surface, the inner surface defining a central bore of the optical fiber cable, the outer surface being an outermost surface of the cable jacket;
a plurality of optical fibers disposed within the central bore, wherein a fiber density of the cable is greater than or equal to 12.0 fibers/mm², wherein each of the plurality of optical fibers comprises:
a mode field diameter (MFD) of between 7.3 μm and 8.4 μm, inclusive, at a wavelength of 1310 nm; and
an outer coating diameter of less than or equal to 174 μm.

2. The optical fiber cable of claim 1, wherein each of the optical fibers has a zero dispersion wavelength between 1300 nm and 1350 nm.

3. The optical fiber cable of claim 1, wherein each of the optical fibers has a macrobend loss of less than 0.5 dB/turn at 1550 nm at a bend diameter of 15 mm.

4. The optical fiber cable of claim 1, wherein the outer coating diameter of each of the optical fibers is less than or equal to 165 μm.

5. The optical fiber cable of claim 1, wherein, when viewed in a cross-section taken orthogonal to a longitudinal axis of the optical fiber cable, a ratio of a cross-sectional area of plastic elements to a cross-sectional area of strength elements is between 4 and 8.

6. The optical fiber cable of claim 1, wherein each of the optical fiber comprises a primary coating and a secondary coating, wherein a ratio of thickness of the primary coating to thickness of the secondary coating is between 0.8 and 1.2.

7. The optical fiber cable of claim 1, wherein each of the optical fibers comprises a primary coating and a secondary coating, wherein an in-situ modulus of the secondary coating is greater than or equal to 1400 MPa.

8. The optical fiber cable of claim 7, wherein the in-situ modulus of the secondary coating is greater than or equal to 2000 MPa.

9. The optical fiber cable of claim 7, wherein the in-situ modulus of the secondary coating is greater than or equal to 2500 MPa.

10. The optical fiber cable of claim 1, wherein the cable jacket has a coefficient of linear thermal expansion of less than or equal to 100 ppm/C.° at 20° C.

11. The optical fiber cable of claim 1, wherein the MFD of each of the plurality of optical fibers is between 7.4 μm and 8.4 μm, inclusive, at a wavelength of 1310 nm.

12. The optical fiber cable of claim 1, wherein each of the plurality of optical fibers exhibits an attenuation increase of less than 0.15 dB/km at −20° C. during a temperature cycling test performed according to IEC 60794-1-212:2024.

13. The optical fiber cable of claim 1, wherein each of the plurality of optical fibers exhibits a cable cutoff of less than 1260 nm.

14. The optical fiber cable of claim 13, wherein the cable cutoff of each of the plurality of fibers is greater than 1125 nm.

15. The optical fiber cable of claim 1, wherein each of the plurality of optical fibers comprises a primary coating, wherein an in-situ modulus of the primary coating is less than 0.25 MPa.

16. The optical fiber cable of claim 1, wherein the optical fiber cable fails to include a central strength member.

17. The optical fiber cable of claim 1, wherein each of the plurality of optical fibers comprises:
a core region; and
a cladding region surrounding and directly adjacent to the core region, wherein an outside diameter of the cladding region is between 76 μm and 126 μm.

18. The optical fiber cable of claim 1, wherein each of the plurality of optical fibers comprises:
a core region; and
a cladding region surrounding and directly adjacent to the core region, wherein the cladding region comprises:
a trench cladding region surrounding the core region, wherein the trench cladding region has a trench volume greater than 30% Δ-μm².

19. The optical fiber cable of claim 1, wherein the optical fibers are loosely disposed in one or more subunits.

20. The optical fiber cable of claim 1, wherein the optical fibers are disposed in intermittently-bonded ribbons.
